(19) United States
(12) Patent Application Publication
(10) Pub. No.: US 2006/0039335 A1
(43) Pub. Date: Feb. 23, 2006

(54) Communication device simultaneously using plurality of routes corresponding to application characteristics

(75) Inventors: Hideaki Ono, Hagi (JP); Hideaki Takusagawa, Kawasakii (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/043,332

(22) Filed: Jan. 26, 2005

(30) Foreign Application Priority Data
Aug. 20, 2004 (JP) 2004-241082

(51) Int. Cl. H04Q 7/24; H04B 7/216

(52) U.S. Cl. 370/338; 370/335

(57) ABSTRACT

A communication device capable of communicating with a receiving device by simultaneously using a plurality of network media existing between the receiving device and the communication device, comprises a determining section determining, from within the plurality of network media, at least one network media satisfying a request condition of a communication application used for the communication, and a communication section performing the communication with the receiving device by use of at least one network media.

### BACKGROUND OF THE INVENTION

1. Field of the Invention

The invention relates to a communication device in the field of fixed network communications and mobile communications.

2. Description of the Related Art

At the present, advancements in communication technologies have made it possible to utilize a variety of network media (which are also called “links.” An ISDN (Integrated Services Digital Network) network, a PDC (Personal Digital Cellular Telecommunication System) network, a PHS(Personal Handy Phone)network, a W-CDMA (Wideband-Code Division Multiple Access) network, a wireless LAN (Wireless Local Area Network), and etc.). Each of the network media has a different characteristic. Therefore, an end user selects the network media to be utilized in accordance with a usage purpose thereof.

At the present, the use of a mobile IP (Internet Protocol) technology is going to enable a continuation of communications (seamless communications) by switching the network media between plural types of networks (e.g., between the cellular network and the wireless LAN).

Further, a communication application (such as HTTP (HyperText Transfer Protocol), FTP (File Transfer Protocol), VOIP (Voice over IP), SMTP (Simple Mail Transfer Protocol), etc.) used for the communications has characteristics (delay time, a bandwidth and so on) according to the purpose thereof.

Incidentally, the single network media has an upper limit in its usable bandwidth. Diversification of the communication applications leads to a prediction that the communication bandwidth will become deficient from now onward. Technologies (refer to, e.g., Non-Patent documents 1 and 2) that bundles a plurality of network media exist as technologies for supplementing the deficiency in bandwidths.

According to the technology described in Non-Patent document 1, a network bundling device is placed between a transmitting device and a receiving device at both ends. The network bundling device bundles the bandwidths of multiple network media that can be used between the transmitting device and the receiving device. The technology described in Non-Patent document 2 is also capable of ensuring the bandwidths by bundling multiple network media into the single media in the same manner as the technology of Non-Patent document 1.

When utilizing the technologies described in Non-Patent documents 1 and 2, as shown in FIG. 26, in a case where the first network media (a link #1) can use 5 Mbps, the second network media (a link #2) can use 1 Mbps and the third network media (a link #3) can use 2 Mbps between the transmitting device and the receiving device, bundling all these bandwidth results in a total usable bandwidth of 8 Mbps between the transmitting device and the receiving device.

It should be noted that a technology described in Non-patent document 3 is given as the prior art related to the invention of the present application.

[Non-Patent document 1] “Development of [Line Bundling Device] capable of bundling a variety of lines as a broadband network (May 12th in 2004),” http://www.nhk.or.jp/pr/marukaji/m-giju110.html

[Non-Patent document 2] NEC Internet System Research Institute, Mobile Inverce Mux in 200, General Meeting of Electronic Information Communications Association, manuscript B-5-163

[Non-Patent document 3] IETF MIP6 Working Group INTERNET DRAFT “Filters for Mobile IPv6 Bindings (NOMADv6) draft-nomadv6-mobileip-filters-02.txt,” May in 2004

In the technologies disclosed in Non-Patent documents 1 and 2, the plurality of network media capable of ensuring the bandwidths are selected without considering a usage mode and other characteristics of the communication application. In this case, there is a possibility of selecting the network media unsuited to the use of this communication application.

### SUMMARY OF THE INVENTION

One of objectives of the present invention is providing a communication device capable of communicating with a receiving device by use of the network media corresponding to a request condition taking a usage mode and characteristics of a communication application into consideration.

The present invention adopts the following configurations in order to solve the problems described above. Namely, the present invention is a communication device capable of communicating with a receiving device by simultaneously using a plurality of network media existing between the receiving device and the communication device, comprising determining section determining, from within the plurality of network media, at least one network media satisfying a request condition of a communication application used for the communication, and communication section performing the communication with the receiving device by use of at least one network media.

Further, the present invention is a communication device capable of communicating with a receiving device by simultaneously using a plurality of network media existing between the receiving device and the communication device, comprising a plurality of network interfaces of which at least one network interface is prepared for each network media, determining section determining, from within the plurality of network media, at least one network media satisfying a request condition of a communication application used for the communication, and communication section performing the communication with the receiving device by use of at least one network interface associated with at least one network media.

In the present invention, the request condition contains a delay time condition and a bandwidth condition, and the determining section can be constructed to extract one or more network media satisfying the delay time condition from within the plurality of network media that should be used for the communication application, and if a single network media out of the extracted network media can satisfy the bandwidth condition, this single network media is determined as at least one of the network media satisfying the request condition of the communication application, but if no such network media exists and if a combination of two or more network medias out of the extracted network media can satisfy the bandwidth condition, this combination of two or more network medias bundled as one is determined as at least one of the network media satisfying the request condition of the communication application.

Moreover, the communication section in the present invention can be constructed to include application type determining section judging a communication application type of a packet that should be transmitted to the receiving device for every packet, and packet processing section selecting, for every packet, one of the one or more network media associated with at least one network media satisfying a communication quality condition requested by the judged communication application type, and transferring the packet to the selected network interface so that the packet is sent from the selected network interface.

In this case, it is preferable that the determining section is constructed to determine the ratio of the packets sent to each network media when a combination of two or more network media bundled as one has been determined as at least one of the network media satisfying the request condition of the communication application, and the packet processing section is constructed to executes a process of transferring the packets to the selected network interfaces according to the determined ratio.

Furthermore, in the present invention, it is preferable to take such a scheme that the plurality of network media that should be used for the communication application are extracted from within the plurality of network media existing between the receiving device and the communication device in consideration of a usage mode and/or a characteristic of the communication application.

In the present invention, the “network media” as an object for determination can be replaced by one of a “route” and an “address”.

### BRIEF DESCRIPTION OF THE DRAWINGS

FIG. 1 is an explanatory view of an outline of an embodiment of the present invention;

FIG. 2 is a functional block diagram showing a communication device related to the outline f the embodiment of the present invention, and showing an example of a configuration of a first embodiment of the communication device of the present invention;

FIGS. 3A, 3B and 3C are diagrams showing a first application pattern of the communication device according to the embodiment, and showing a case in which the communication device is applied to the transmitting terminal or a router;

FIG. 4 is a diagram showing a second application pattern of the communication device according to the embodiment, and showing a case in which the communication device is applied to an edge router;

FIGS. 5A and 5B are diagrams showing a third application pattern of the communication device according to the embodiment, and showing a case in which the communication device is applied to a mobile IP home agent;

FIGS. 6A and 6B are diagrams showing a fourth application pattern of the communication device according to the embodiment, and showing a case in which the communication device is applied to a transmitting terminal having a plurality of addresses or to a router;

FIG. 7 is a diagram showing an example of a structure of an application characteristic management table retained by an application characteristic management module in the first embodiment;

FIG. 8 is a diagram showing an example of a structure of a network characteristic management table retained by a network characteristic management module in the first embodiment;

FIG. 9 is a diagram showing an example of a structure of a cache table in the first embodiment;

FIG. 10 is a flowchart showing an operation sequence when a packet arrives in the first embodiment;

FIG. 11 is a flowchart showing a packet transfer rule determining sequence in the first embodiment;

FIG. 12 is a functional block diagram showing an example of a configuration of a second embodiment of the communication device of the present invention;

FIG. 13 is a diagram showing an example of a structure of the application characteristic management table in the second embodiment;

FIG. 14 is a diagram showing an example of a structure of the network characteristic management table in the second embodiment;

FIG. 15 is a diagram showing a structure of a cache table in the second embodiment;

FIG. 16 is a flowchart showing an operation sequence when the packet arrives in the second embodiment;

FIG. 17 is a flowchart showing the packet transfer rule determining sequence in the second embodiment;

FIG. 18 is a functional block diagram showing an example of a configuration of a third embodiment of the communication device of the present invention;

FIG. 19 is a diagram showing an example of a structure of the cache table in the third embodiment;

FIG. 20 is a flowchart showing an operation sequence when the packet arrives in the third embodiment;

FIG. 21 is a flowchart showing a packet transfer rule determining sequence in the third embodiment;

FIG. 22 is a functional block diagram showing an example of a configuration of a fourth embodiment of the communication device of the present invention;

FIG. 23 is a diagram showing an example of a structure of the cache table in the fourth embodiment;

FIG. 24 is a flowchart showing an operation sequence when the packet arrives in the fourth embodiment;

FIG. 25 is a flowchart showing a packet transfer rule determining sequence in the fourth embodiment; and

FIG. 26 is an explanatory view of the prior art.

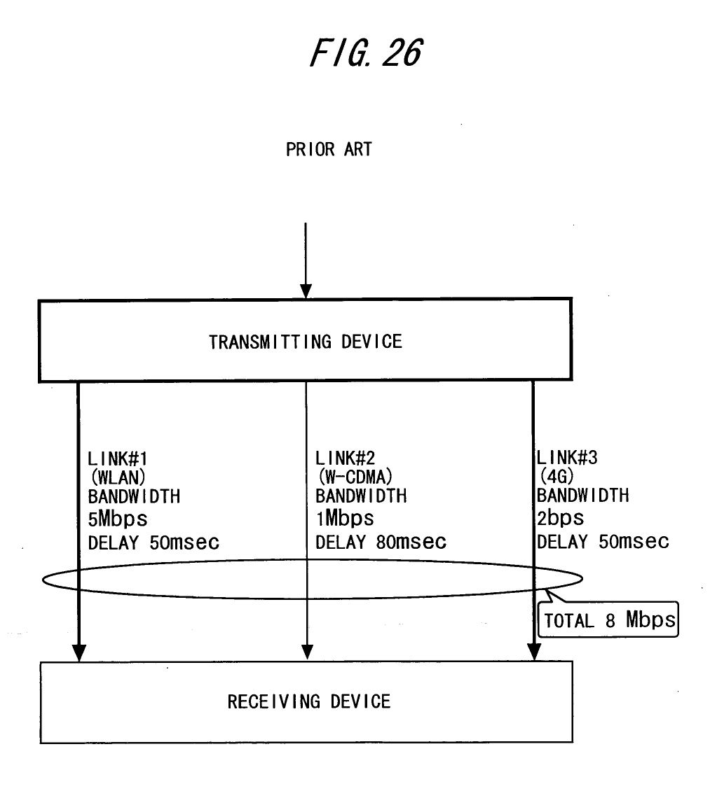

### DETAILED DESCRIPTION OF THE PREFERRED EMBODIMENTS

Embodiments of the present invention will hereinafter be described with reference to the drawings. Configurations of the embodiments are exemplifications, and the present invention is not limited to the configurations of the embodiments.

[Outline of Embodiment]

An outline of the embodiment will hereinafter be explained. In a communication device according to the embodiment of the present invention, a network media is selected corresponding to a request condition of a communication application (which will hereinafter be simply referred to as an “application”) used for communications. The request condition is specified (defined) in consideration of a usage mode of the application by the user and characteristics (delay time, a bandwidth, etc.) of the network media employed by the application.

If a single network media does not meet (satisfy) a bandwidth condition (a lack of bandwidth) requested by the application, a communication device satisfies the bandwidth condition by combining plural network media. To be specific, if the request condition of the application is met by utilizing the single network media, the plural network media are not utilized.

The communication device excludes from selection candidates the network media that do not meet the request condition of the application, and selects a should-be-used application from within the network media that meet the request condition of the application.

Herein, the “network media” are also referred to as “links.” Further, a “packet transfer route”, an “IP destination address” and an “IP source address” might become objects for selection as substitutes for the “network media.”

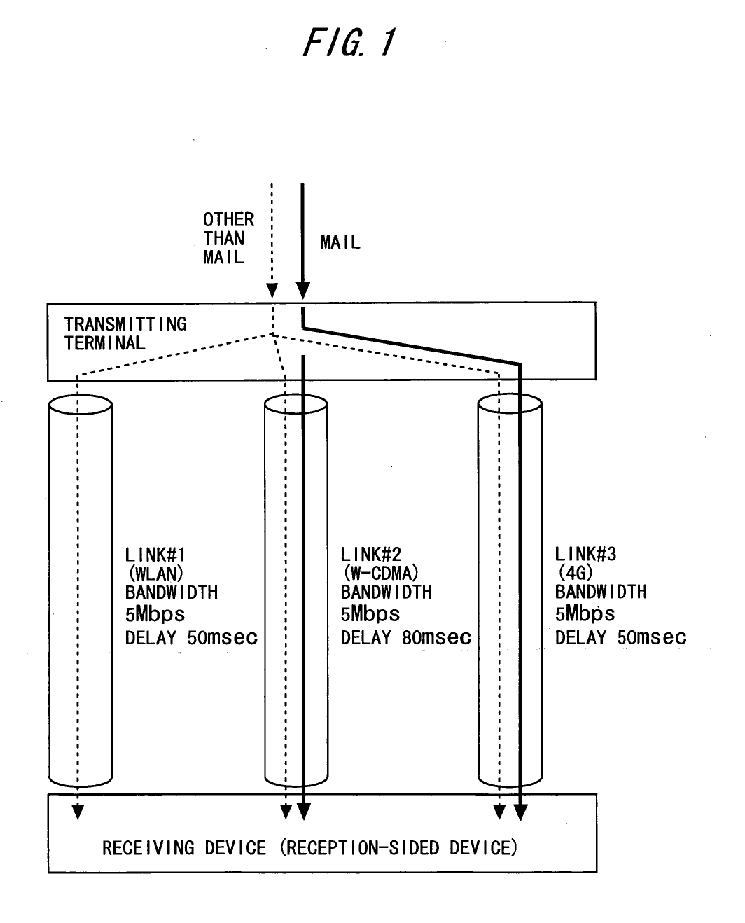

FIG. 1 is an explanatory view of the embodiment. In FIG. 1, tree network media (links #1 through #3) exist between a transmitting device and a receiving device, and the transmitting device and the receiving device are capable of performing the communications by use of the respective links #1 through #3. The transmitting device corresponds to a communication device according to the present invention, and the receiving device corresponds to a receiving device according to the present invention.

The link #1 is a wireless LAN (which will hereinafter also be abbreviated to “WLAN”), wherein a bandwidth is on the order of 5 Mbps, and a delay is 50 milliseconds. The link #2 is a W-CDMA (which will hereinafter also be termed “3G” (the third generation mobile communication system)) network, wherein the bandwidth is 500 kbps, and the delay is 80 milliseconds. The link #3 is a 4G (the fourth generation mobile communication system) network, wherein the bandwidth is 2 Mbps, and the delay is 50 milliseconds.

The transmitting device can perform the communications by utilizing the plurality of applications. The request condition of each application is different for every application, and the characteristics of the network media utilizable by the application are also different for every network media. The transmitting device can select at least one proper network media from within the plural network media (links) and can use the selected media for every application. In the case of using the plural applications simultaneously, the plural network media can be simultaneously utilized by selecting and using at least one network media corresponding to each application.

It should be noted that the applicant (Fujitsu Ltd.) of the present application already made patent applications (“Application Handover Method in Mobile Communication System, and Mobile Management Node and Mobile Node Used in the Same Mobile communication System”, filed to the Japanese Patent Office on May 20, 2003, and Japanese Patent Application No. 2004-050589, “Communication Device”, any of which is not yet laid open) about a technology of simultaneously utilizing the plurality of network media by selecting one optimum media from within the plurality of network media utilizable by the application and using the selected media for every application.

The transmitting device shown in FIG. 1, when transmitting an electronic mail to the receiving device by use of an application for “E-mail Transmission”, selects the links #2 and #3 as the links for transmitting the electronic mail but does not select the link #1 (the wireless LAN). This is because the wireless LAN has a possibility that the electronic mail might be unlawfully intercepted.

In this respect, the transmitting device, when utilizing the application excluding the “E-mail Transmission,” uses at least one of the links #1, #2 and #3. The transmitting device and the receiving device can use simultaneously the E-mail Transmission application and an application other than this E-mail Transmission application. For example, the transmitting device and the receiving device transmit and receive the electronic mails by use of the link #2, and simultaneously can perform the communications based on other application by using the link #1.

Further, the transmitting device and the receiving device, if unable to ensure the bandwidth requested by the application on one single link, can ensure the requested bandwidth by using two or more links at the same time. For instance, when a certain application requests a bandwidth of 7 Mbps, it is possible to ensure the bandwidth requested from the application by simultaneously utilizing, e.g., the link #1 (5 Mbps) and the link #3 (2 Mbps).

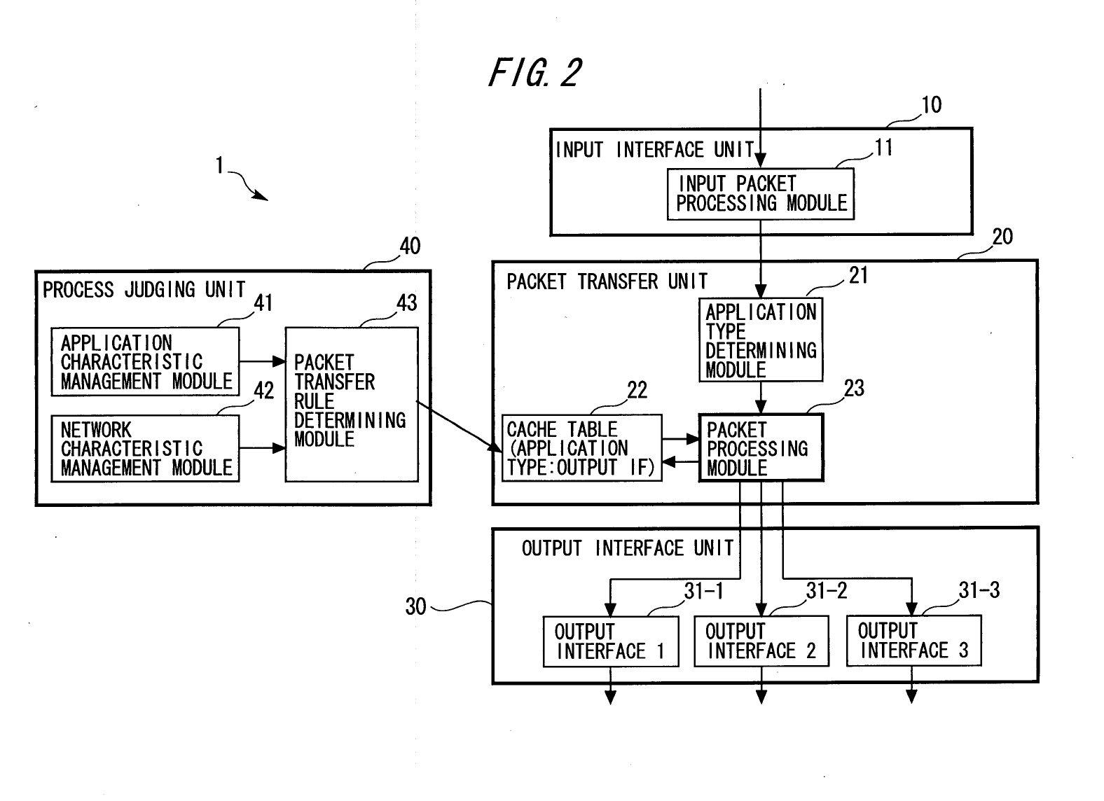

FIG. 2 is a diagram showing an example of a configuration of the communication device according to the embodiment of the present invention. In FIG. 2, a communication device 1 includes an input interface unit 10, a packet transfer unit 20, an output interface unit 30 and a process judging unit 40.

The input interface unit 10 has an input packet processing module 11. The input packet processing module 11 executes a predetermined input packet process upon a packet (the packet reaching the communication device 1) inputted to the input interface unit 10, and thereafter inputs the packet to the packet transfer unit 20.

The output interface unit 30 has a plurality (n-pieces (n is a natural number) of output interfaces (output IFs). FIG. 2 shows, by way of an example, three pieces of output interfaces 31-1, 31-2, and 31-3. Note that the respective interfaces are, if shown without any distinction, referred to as the “output interface 31.” Each output interface 31 effects a predetermined output packet process upon the packet inputted from the packet transfer unit 20, and thereafter sends this packet to the link corresponding thereto.

The packet transfer unit 20 includes an application type judging module 21 that judges an application type applied to the packet for every packet inputted from the input interface unit 10, a cache table 22 stored with identifying information of one of the output interface (the output IF) 31 associated with the application type, and a packet processing module 23.

The packet processing module 23 receives the packet and the application type applied to this packet from the application type judging module 21. The packet processing module 23 determines one of the output interface 31 from which the packet should be outputted in a way that refers to the cache table 22, and transfers the packet to the thus-determined output interface 31.

The process judging unit 40 manages and grasps the application characteristics and the network media characteristics, and judges an optimum network media utilized by the application for every application.

The process judging unit 40 includes an application characteristic management module 41 that manages characteristic information of each application, and a network media characteristic management module 42 that manages characteristic information of each network media (link), and retains associated relations, as the application characteristic information and the network media characteristic information, between the respective applications and the network media utilizable by the respective applications.

Moreover, the process judging unit 40 includes a packet transfer rule determining module 43. The packet transfer rule determining module 43 creates a packet transfer rule on the basis of the application characteristics and the network media characteristic information, and stores the cache table 22 with the information based on the created rule.

Namely, the packet transfer rule determining module 43 calculates beforehand which output interface 31 of the packet should be transmitted to in accordance with the application type of the packet reaching the communication device 1, and stores a result of this calculation in the cache table 22 within the packet transfer unit 20.

When the packet arrives at the communication device 1, this packet is received by the input interface unit 10 and inputted to the packet transfer unit 20. In the packet transfer unit 20, the packet type determining module 21 determines the application type of the packet. The application type can be judged by, e.g., a method of reading a port number contained in the packet or by a method of referring to a packet data field thereof.

In the packet transfer unit 20, the application type determining module 21 determines the application type of the packet each time the packet is reached. The packet processing module 23 determines, for every packet, a processing method for the packet by referring to the cache table 22, and executes the packet process according to a result thereof.

The packet processing module 23 determines, as the packet process, for example, the output interface 31 as the packet output destination (a transfer destination) by referring to the cache table 22. Subsequently, the packet processing module 23 processes the packet according to the necessity so that the packet is transmitted from the determined output interface 31, and thereafter transfers the packet to the output interface 31.

Further, the packet processing module 23 updates processing contents such as showing which output interface 31 of the packet should be next transferred to in preparation for a next arrival of the packet, etc., and stores updated contents in the cache table 22.

The example in FIG. 2 shows a case (example) in which the output interface unit 30 is provided with the plurality of output interfaces 31. As a substitute for this, the packet is encapsulated with an IP packet as by Mobile IP Home Agent, etc., whereby a destination address of the packet can be also selected. In such a case, the number of the output interface 31 may be singular.

Note that the process judging unit corresponds to a determining unit according to the present invention, and the packet transfer unit 20 and the output interface unit 30 correspond to communication unit according to the present invention. Further, the output interface corresponds to a network interface according to the present invention. Moreover, the application type determining module 21 corresponds to an application type determining unit, and the packet processing module 23 corresponds to a packet processing unit according to the present invention.

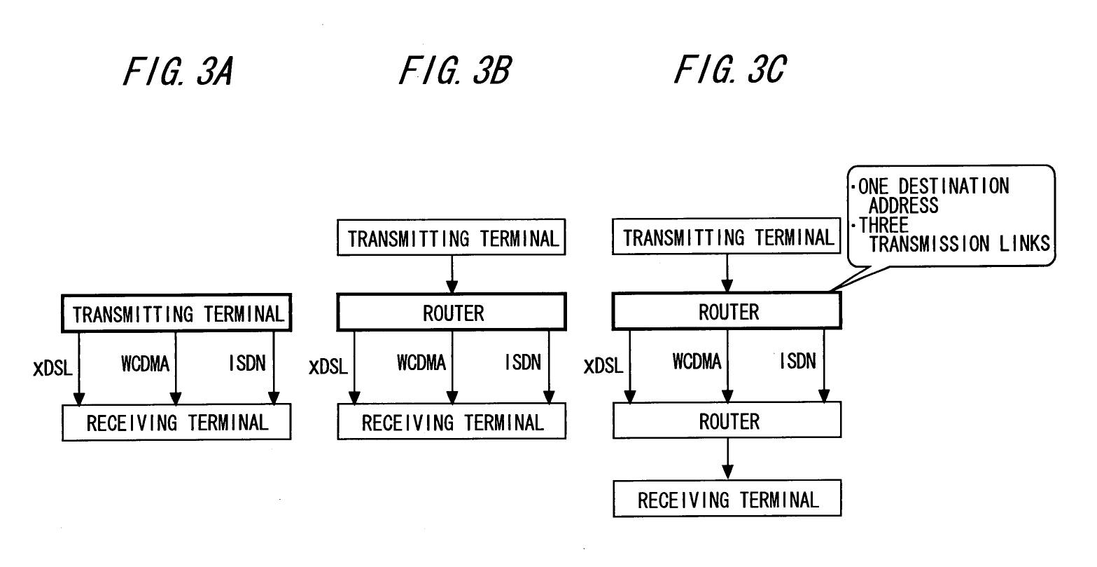

FIGS. 3 through 6 are diagrams showing application patterns of the communication device in the embodiment. The communication device in the embodiment can be applied to a transmitting terminal (the transmitting device) of the packet, a relay device such as a router for routing and forwarding the packet, or a mobile management device such as the home agent based on the mobile IP, and so on.

FIGS. 3A, 3B and 3C are diagrams showing a first application pattern of the communication device. The first application pattern shows a case that a destination address of the packet is one address, and there is the plurality of network media capable of sending the packet. FIGS. 3A, 3B and 3C show a case where three types of network media (xDSL (x Digital Subscriber Line), W-CDMA and ISDN) can be used between the transmitting terminal and the receiving terminal. FIG. 3A shows a case in which the communication device in the embodiment (FIG. 2) is applied to the transmitting terminal. The receiving terminal corresponds to a receiving device.

FIG. 3B shows a case that a router is interposed between the transmitting terminal and the receiving terminal, and the three types of network media can be used between the router and the receiving terminal. In the example in FIG. 3B, the communication device in the embodiment is applied to the router, and the receiving terminal corresponds to the receiving device.

Furthermore, FIG. 3C shows a case that two pieces of routers are interposed between the transmitting terminal and the receiving terminal, and the three types of network media can be used between the routers. In the example in FIG. 3C, the communication device in the embodiment is applied to the transmission-sided router, and the receiving router corresponds to the receiving device. As illustrated in FIGS. 3B and 3C, the present invention can be applied also to a case that multi-links are established in part of between the transmitting terminal and the receiving terminal.

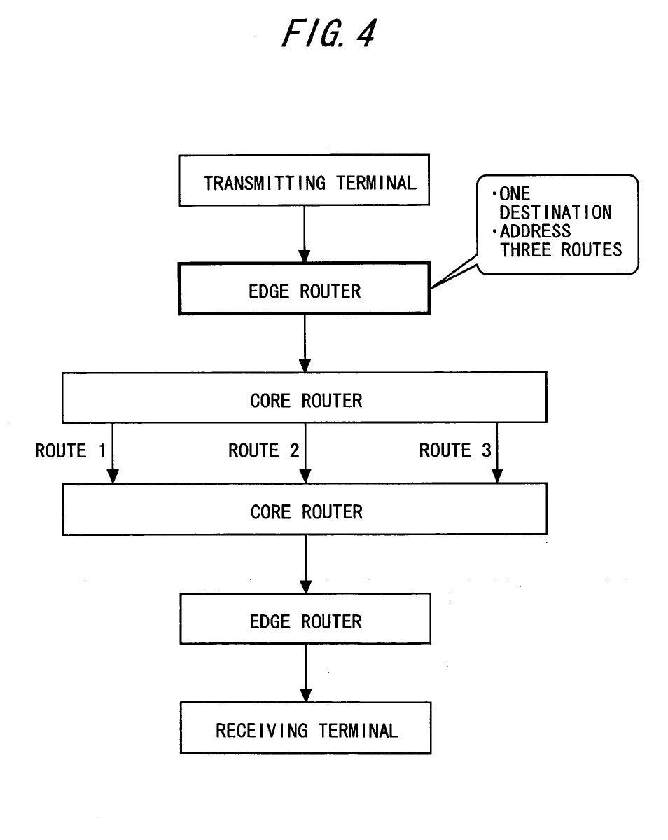

FIG. 4 is the diagram showing a second application pattern of the communication device. In the second application pattern, a single destination address of the packet and a plurality of packet transfer routes (e.g., LSPs (Label Switched Paths) based on MPLS (Multi Protocol Label Switching)) between the transmitting terminal and the receiving terminal exist.

In FIG. 4, MPLS-based edge routers and MPLS-based core routers are respectively interposed between the transmitting terminal and the receiving terminal, and the plurality (numbered three herein) of transfer routes are set between the core routers. In the example in FIG. 4, the communication device in the embodiment (FIG. 2) is applied to the transmission-sided edge router. The receiving edge router corresponds to the receiving device.

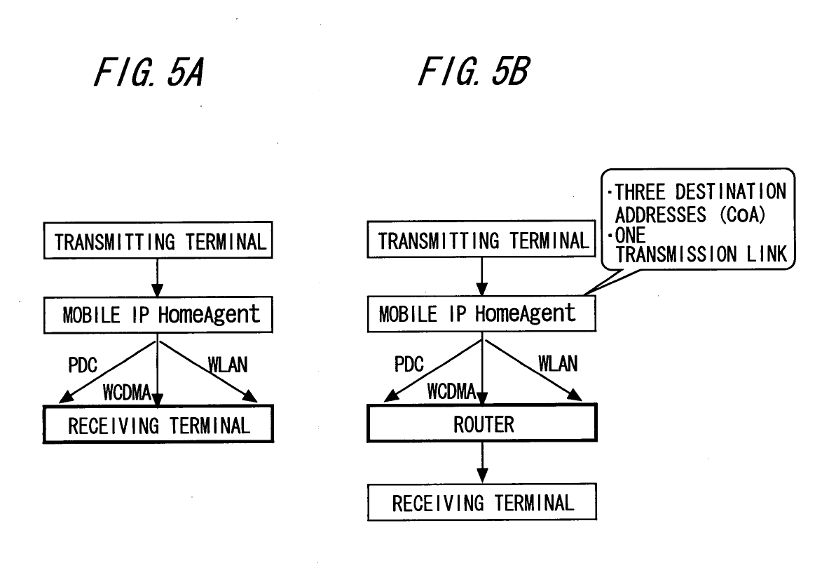

FIGS. 5A and 5B are the diagram showing a third application pattern of the communication device. The third application pattern is such a case that the home agent is interposed between the transmitting terminal and the receiving terminal defined as a mobile IP based mobile node (mobile node: MN), wherein a plurality (which represents three types herein) of Care-of-Addresses (CoA) of the receiving terminal are registered in the home agent, and the home agent encapsulates and transfers the packet addressed to one or more CoAs among those CoAs in accordance with the application characteristics.

In the third application pattern, the destination address is an object to be selected corresponding to the application. It is to be noted that FIG. 5 shows a case in which the home agent can use a PDC network, a W-CDMA network and a WLAN serving as the plurality of simultaneously-usable network media (links).

In FIG. 5A, the home agent is interposed between the transmitting terminal and the receiving terminal. In FIG. 5B, the router is interposed between the home agent and the receiving terminal. In each of the examples in FIGS. 5A and 5B, the communication device in the embodiment (FIG. 2) is applied to the home agent.

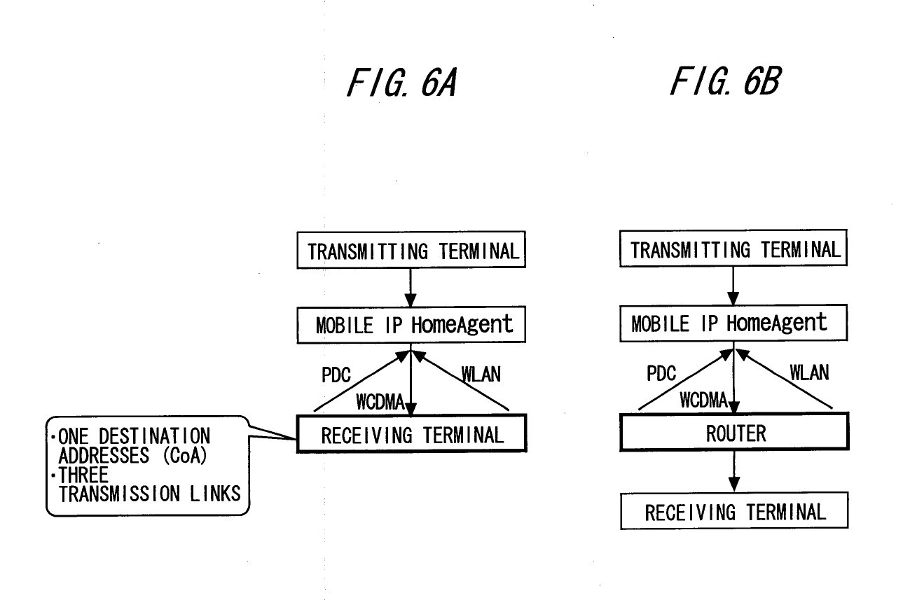

FIGS. 6A and 6B are diagrams showing a fourth application pattern of the communication device. The fourth application pattern is a case that the destination address of the packet is one address, and a plurality (numbered three herein) of origination (source) addresses are usable.

FIG. 6A shows a case that the home agent is interposed between the transmitting terminal and the receiving terminal as the mobile nodes, the transmitting terminal has three pieces of CoAs, one or more CoAs corresponding to the request condition of the application are determined from the three pieces of CoAs, one of the determined CoAs is set in the source address (origination address), and the packet in which a home address of the receiving terminal is set in its destination address, is transmitted to the home agent. Further, FIG. 6B shows a case that the router is interposed between the transmitting terminal and the home agent, and the router executes the same operation as the transmitting terminal in FIG. 6A does.

FIGS. 6A and 6B show that the packet can be transferred between the transmitting terminal and the home agent and between the router and the home agent by use of the PDC network, the W-CDMA network and the WLAN. In FIG. 6A, the communication device of the present invention (FIG. 2) is applied to the transmitting terminal. In FIG. 6B, the communication device of the present invention (FIG. 2) is applied to the router.

### First Embodiment

A first embodiment of the present invention will hereinafter be described. The first embodiment exemplifies an example of applying the communication device in the embodiment to the relay device in the network. Namely, the first embodiment is an embodiment corresponding to the first application pattern shown in FIGS. 3B and 3C.

The configuration of the communication device 1 illustrated in FIG. 2 can be applied to the communication device in the first embodiment. When the communication device 1 is applied to the packet relay device, the communication device 1 receives the packet from an external terminal device through the input interface unit 10 thereof via the network. Note that the configuration of the communication device 1 shown in FIG. 2 can be applied also to the transmitting terminal as shown in FIG. 3A. In this case, the communication device receives the packet from the application on the communication device itself.

In FIG. 2, the input interface unit 10 has the input processing module 11. The input packet processing module 11, in the same way as a receiving portion of a normal network device does, judges whether or not the packet reached is a packet that should be processed by the communication device itself, and so forth. When the reached packet is a packet to be processed by the communication device itself, the input packet processing module 11 transfers the reached packet to the packet transfer unit 20.

In the packet transfer unit 20, when the packet is inputted thereto, the application type determining module 21 judges a type of the application carried on this packet.

The packet processing module 23 searches through the cache table 22, wherein the application type determined by the application type determining module 21 is used as a (search) key. With this operation, the packet processing module 23 knows processing contents of the packet.

The cache table 22 retains (stores) a result of the packet transfer route determined by the process judging unit 40. The process judging unit 40 determines a packet transfer rule per application on the basis of the application characteristics and the network characteristics, and registers a result thereof in the cache table 22.

The processing contents of the packet show, for example, one of the output interfaces 31 which should output a next packet with respect to a certain application. The packet processing module 23 executes, upon the packet, packet processing according to the processing contents read from the cache table 22, and outputs the packet toward the desired output interface 31.

The output interface unit 30 has the three output interfaces 31 by way of the example of the plurality of output interfaces. The output interface unit 30 output the packet from any one of the three output interfaces 31 in accordance with the result of the packet processing. In the first embodiment, the output interface unit 30 is required to have a plurality of output interfaces 31 and is also required to be prepared with at least one single output interface 31 for each network media used by the application.

Each output interface 31 can involve applying an interface card and so on. In the first embodiment, an output interface 31-1 is connected to a 3G network, an output interface 31-2 is connected to a 4G network, and an output interface 31-3 is connected to a WLAN.

The process judging unit 40 includes the application characteristic management module 41, the network characteristic management module 42 and the packet transfer rule determining module 43. The application characteristic management module 41 retains (information about) what request condition each of the individual applications has. What can be assumed as the request condition may be, for example, a bandwidth needed for satisfying quality when the application performs a communication, a packet transfer delay, a priority level of the network media that should be utilized, the network media that is not utilized, and so forth.

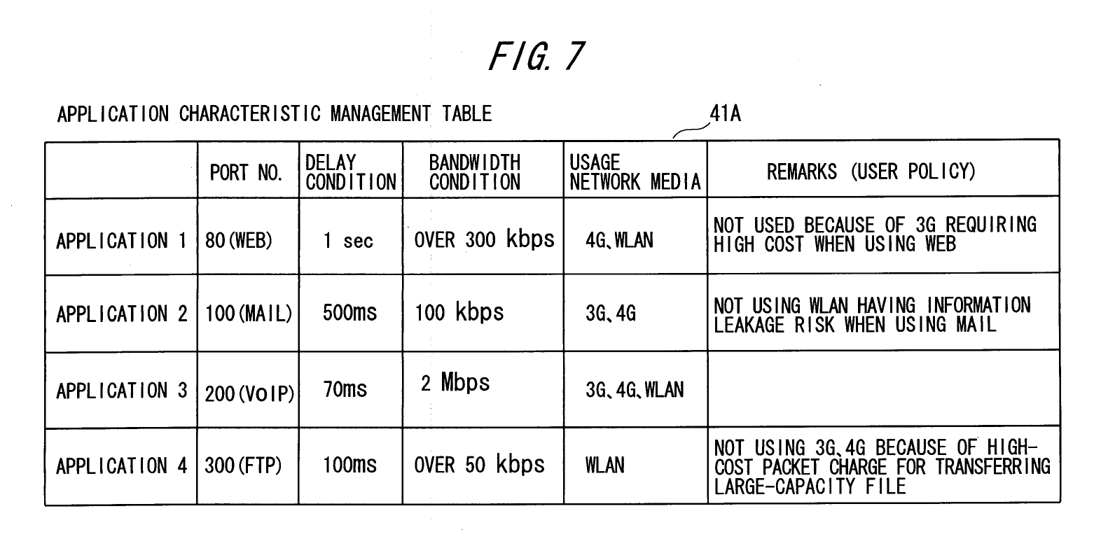

FIG. 7 shows an example of a structure of an application characteristic management table 41A retained by the application characteristic management module 41. The application characteristic management table 41A is stored with records each containing a port number, a delay condition, a bandwidth condition, a type of the network media that should be utilized and a user policy for every application.

The application type can be judged by referring to a port number contained in a header of the IP packet based on TCP (Transmission control Protocol) or UDP (User Datagram Protocol). In this example, a Web (HTTP (HyperText Transfer Protocol)), an E-mail (SMTP (Simple Mail Transfer Protocol)), VoIP (Voice over IP), and FTP (File Transfer Protocol) are exemplified as the applications.

For instance, the request conditions corresponding to the characteristics of an application 1 such as the delay condition being lower than or equal to 1 second and the bandwidth condition being higher than or equal to 300 kbps, are designated in the application 1 (“Web” in this example) having a port number “80”.

Further, a policy that 3G is not used because of an expensive charge for the communications is set in the application 1. Thus, the type of the network media that should be used by the application registered in the table 41A is specified according to the policy taking into consideration the network media characteristics and the usage mode of the application of the user.

As described above, the application characteristic management table 41A is stored with, as the request conditions of the application, the network media type determined corresponding to the policy, and the delay condition and the bandwidth condition that are based on the application characteristics according to every application type.

The contents stored in the application characteristic management table 41A may be those designated beforehand and may also be those dynamically designated from other server and terminal when starting the communications.

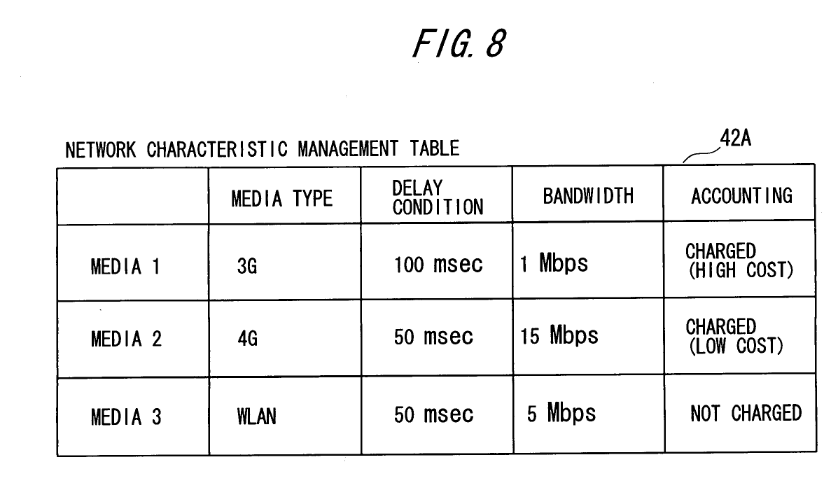

The network characteristic management module 42 grasps and retains statuses of the plurality of network media. FIG. 8 shows an example of a structure of a network characteristic management table 42A retained by the network characteristic management module 42. The network characteristic management table 42A is stored with records each showing (containing) items of network media characteristic information such as a network media type, a delay condition (transfer delay time), a bandwidth (a unused (free) bandwidth) and accounting for every (per) network media (link).

In the example in FIG. 8, the records about the three types of network media such as the 3G, the 4G and the WLAN are stored. The contents stored in the network characteristic management table 42A may be those set previously and may also be those designating results of the network statuses dynamically collected by the terminal and other management server. The delay condition and the bandwidth are, however, updated each time in accordance with a change in the network status.

The packet transfer rule determining module 43 included in the process judging unit 40 judges the processing content when the packet reaches next time on the basis of the information stored in the application characteristic management table 41A and in the network characteristic management table 42A, and stores the processing contents according to every application type in the cache table 22.

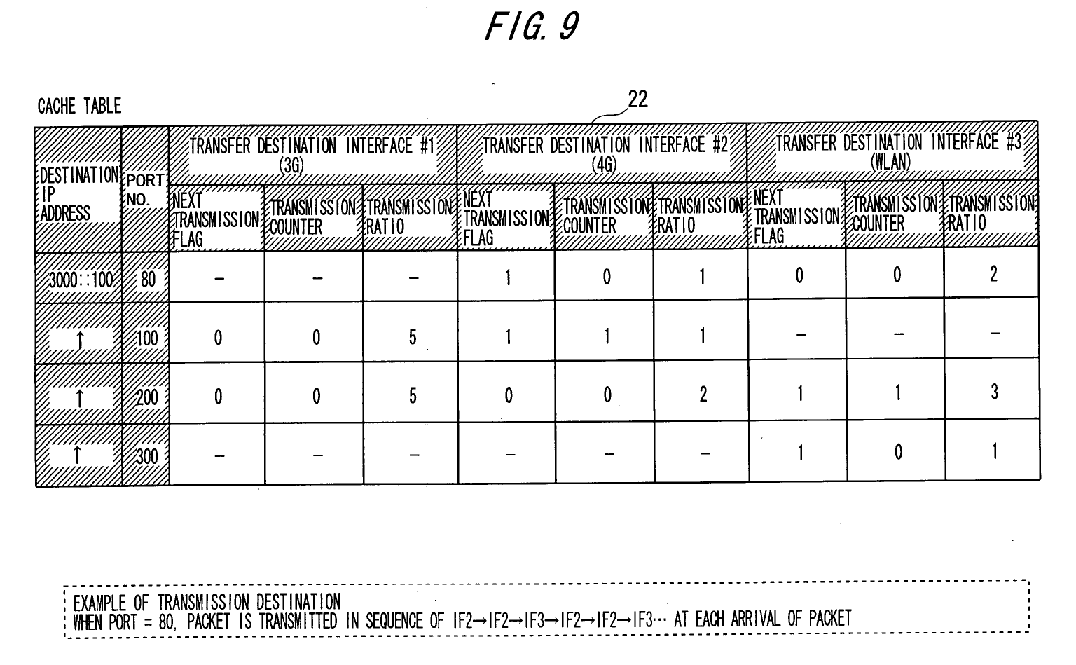

FIG. 9 shows an example of a structure of the cache table 22 for designating what process should be executed upon a next packet for every application. The cache table 22 is created (organized) considering the destination IP address of the packet as a unit. FIG. 9 shows the example of the structure of the cache table 22 in the case of designating which interface among the three transfer destination interfaces (the output interface 31-1 (IF#1), 31-2 (IF#2), (31-3 (IF#3)) the arrived packet is transmitted to.

The cache table 22 contains values of a next transmission flag, a transmission counter and a transmission ratio for every transfer destination (every output interface (output IF)). ON/OFF of the next transmission flag is controlled so that the next packet is transmitted from the output interface 31 having the next transmission flag set to “1”. The transmission counter indicates the number of packets (packet count) transmitted to the output interface 31. The transmission ratio indicates a packet transmission rate between the output interfaces 31 with respect to the single application.

For example, the following method is given as a simplest method of determining the next packet transfer destination. For instance, when the transmission ratio for the application having the port number “80” is 0:1:2, a next packet transfer destinations are designated so that the packet is transferred (forwarded) in the sequence of IF#2→IF#3→IF#3 (which is repeated from now onward) At this time, if the value of the transmission counter becomes coincident with a numeral of the transmission ratio, the packet is transmitted from the next output interface. Then, the transmission counter is cleared when finishing making one cycle of the output interfaces. A variety of transmission scheduling methods (bandwidth control methods) utilized in the QoS (Quality of Service) assuring technology can be applied to the packet transmission sequence determining method.

Further, FIG. 9 shows an example, wherein with respect to the application having a port number “100”, the links of IF#1 and IF#2 are selected, the packets are transferred to IF#1 and IF#2 at a ratio of 5:1 in the selection sequence of IF#1→IF#2. Moreover, FIG. 9 shows an example, wherein with respect to the application having a port number “200”, IF#1, IF#2 and IF#3 are selected, and the packets are transmitted at a ratio of 5:2:3 in the selection sequence of IF#3→IF#1→IF# 2. Still further, FIG. 9 shows an example, wherein with respect to the application having a port number “300”, only IF#3 is selected.

Note that the cache table 22 is created, for example, when detecting the destination IP address of the packet arriving at the communication device 1 upon starting the communications. At this time, a part of the cache table 22 depicted by hatching is created as a table in an initial status. Thereafter, the packet transfer rule determining module 43 determines and writes the transmission ratios for the respective output IFs for every application. Then, the packet processing module 23 controls the next transmission flag and the transmission counter.

A scheme for creating the cache table 22 in the initial status is made, for instance, when the packet processing module 23 monitors the destination IP address of the packet and receives a packet having a destination IP address unrecognized. The creation of the cache table 22 in the initial status may also be conducted in a portion (component) different from the packet processing module 23.

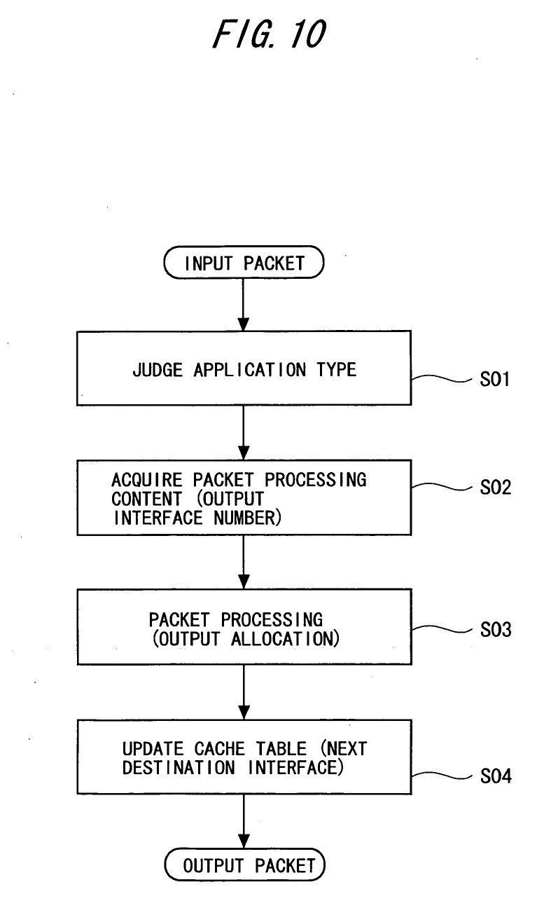

FIG. 10 is a flowchart showing an operation sequence at the time of an arrival of the packet on the communication device (the packet relay device) in the first embodiment. FIG. 10 shows processes particularly by the application type determining module 21 and the packet processing module 23 of the packet transfer unit 20.

A start of the processing in FIG. 10 is triggered by the packet arrival at the input interface unit 10 and by this packet being inputted to the packet transfer unit 20. To begin with, the application type of the packet is judged (step S01). To be specific, the application type determining module 21 extracts the port number contained in the packet, thereby specifying the application type.

Next, a packet processing content is acquired (step S02). Specifically, the packet processing module 23 receives the packet and the application type from the application type determining module 21, then specifies, from the packet destination IP address, the cache table 22 that should be referred to, and acquires an associated processing content (containing the output interface number) with the application type (the port number) used as a key.

Concretely, the packet processing module 23 specifies a record (a column) associated with the port number serving as a key, and reads a transfer destination interface number (the output IF number) in which “1” (ON) is set in the next transmission flag.

Next, the packet processing (output allocation) is executed (step S03). Namely, the packet processing module 23 determines that the packet is transferred (forwarded) to the output IF 31 having the output IF number acquired from the cache table 22.

Subsequently, the cache table 22 is updated (step S04). To be specific, the packet processing module 23 increments by “1” a value in the transmission counter of the associated output IF. Then, the packet processing module 23 judges whether or not the value in the transmission counter is the same as the numeral in the transmission ratio. The packet processing module 23, if these two values are not the same, terminates the processing and, whereas if being the same, sets the value in the next transmission flag of the output IF to “0” (OFF) and sets the value in the next transmission flag of the should-be-next-selected output IF to “1” (ON). Herein, the packet processing module 23, if there is no output IF that should be next selected, clears the values in the respective transmission counters, and thereafter sets “1” (ON) in the next transmission flag to be selected for the first time. Namely, a reset process is executed. Thus, the packet processing module 23 updates the cache table 22 and gets ready for a next packet arrival.

Then, when finishing the process in step S04, the packet is transferred to the selected output IF 31 and is sent to the link associated therewith from this output IF 31.

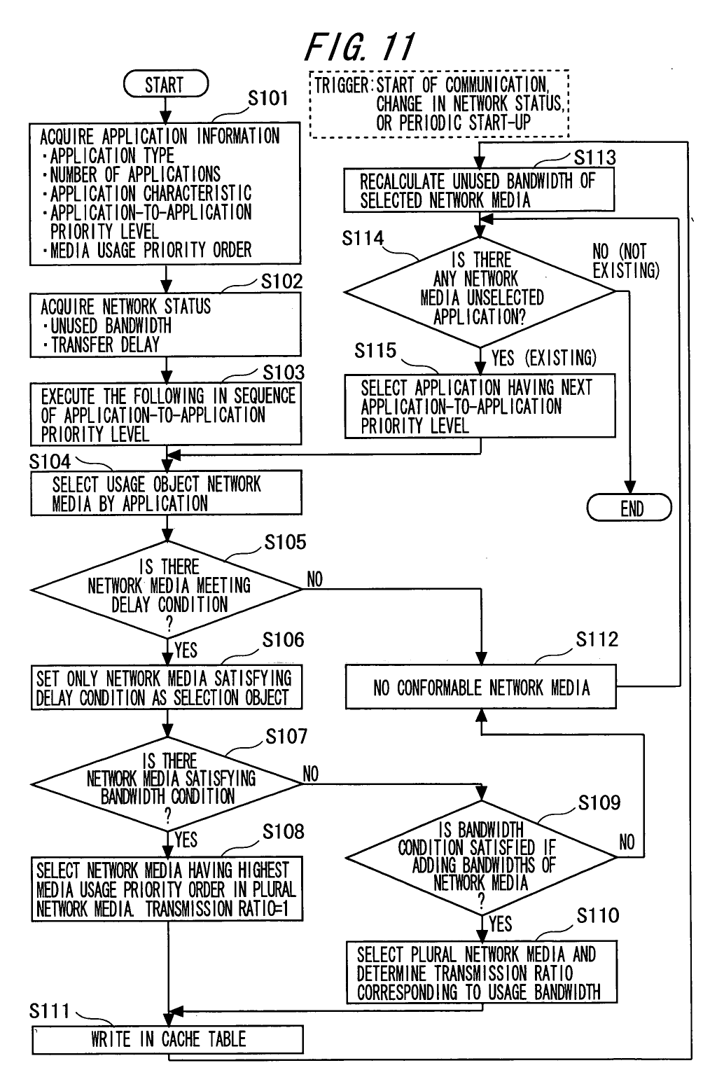

FIG. 11 is a flowchart showing an example of a packet transfer rule determining sequence by the packet transfer rule determining module 43 of the process judging unit 40. A scheme can be taken, wherein a start of the processing shown in FIG. 11 is triggered by starting the communications, or by a change in the network status, or by periodic timing.

Upon a start of the processing shown in FIG. 11, at first, the packet transfer rule determining module 43 acquires the application information (step S101). Specifically, the packet transfer rule determining module 43 acquires the number of applications, the application characteristics, an application-to-application priority level (priority levels among the applications), and a media usage priority order. The types, the number and the characteristic information of the applications can be obtained from the table 41A.

The application-to-application priority level represents a priority order of the applications for the use of the link, and is preset. Further, the media usage priority order represents a usage order of the plural links in a case where each application can use the plurality of network media (links). The application-to-application priority level and the media usage priority order can be previously set in the table 41A.

Next, the packet transfer rule determining module 43 acquires the network status (step S102). For instance, the packet transfer rule determining module 43 acquires the unused bandwidth and the transfer delay time of each network media (link) that are set in the table 42 at that point of time.

Subsequently, the packet transfer rule determining module 43 executes the following processes with respect to the respective application types in the sequence according to the application-to-application priority levels (step S103).

To start with, the packet transfer rule determining module 43 selects the usage object network media by the application (step S104). The network media, in which the network usage policy is reflected, is thereby selected.

Next, the packet transfer rule determining module 43 judges whether or not there are the network media (links) that meet the delay condition requested by the application (step S105). At this time, if there is not the network media that meet (satisfy) the delay condition (S105: NO). The processing proceeds to step S112.

Whereas if there are the network media that meet the delay condition (S105: YES), the packet transfer rule determining module 43 selects only the network media that meet the delay condition as selection objects (step S106).

Next, the packet transfer rule determining module 43 judges whether or not there is the network media in which the unused bandwidth meets the bandwidth condition, in the selection object network media (step S107). At this time, if none of the network media meets the bandwidth condition (S107: NO), the processing advances to step S109. While on the other hand, if there is the network media that satisfies the bandwidth condition (S107: YES), the processing proceeds to step S108.

In step S107, the packet transfer rule determining module 43, if there are the plurality of selection object network media, judges whether or not each of the network media satisfies the bandwidth condition, and, if none of the whole network media satisfies the bandwidth condition, makes the processing proceed to step S109. If there is at least one network media that meets the bandwidth condition, the processing advances to step S108.

Namely, the packet transfer rule determining module 43 extracts the network media satisfying the bandwidth condition, and, if unable to extract, advances the processing to step S109. If able to extract at least one network media, the packet transfer rule determining module 43 advances the processing to step S108.

In step S108, the packet transfer rule determining module 43 selects the network media exhibiting the highest media usage priority order in the extracted network media, and determines the transmission ratio to be “1”. Then, the packet transfer rule determining module 43 writes the determined transmission ratio of “1” in a corresponding field in the cache table 22 (step S111). Namely, the transmission ratio of the selected output IF is set to “1”, while transmission ratios of the remaining output interfaces Ifs are set to “0”. At this time, “1” (ON) is set (default setting) in the next transmission flag of any one of the network media in which a value larger than or equal to “1” is set in their transmission ratios in accordance with the media usage priority order.

A flow (of processing) in steps S107, S108 and S111 described above shows the case of having at least one network media that meets the delay condition and the bandwidth condition. In this case, the packet transfer rule determining module 43 selects only the network media exhibiting the highest media usage priority order in the network media satisfying the delay condition and the bandwidth condition, and writes this network media in the cache table 22 so that the packet is transferred to the output IF 31 associated with this selected network media.

By the way, when the processing advances to step S109, the packet transfer rule determining module 43 judges whether the bandwidth condition is met or not if adding unused bandwidths of the plurality of network media satisfying the delay condition. At this time, the packet transfer rule determining module 43 can calculate the unused bandwidths of the plurality of network media in various combinations of the network media. Then, when having detected the combinations of plural network media satisfying the bandwidth condition, a single combination of network media is extracted based on a predetermined selection policy. For example, the single combination of network media can be extracted according to the media usage priority order.

In step S109, if the bandwidth condition is not met (S109: NO), it is judged that there exists no conformable network media (step S112), and the processing proceeds to step S114.

Whereas if the bandwidth condition is satisfied (S109: YES) the packet transfer rule determining module 43 selects the combination of plural network media extracted in step S109 as the network media applied to the application, and determines the transmission ratio of the packet to each network media in accordance with the bandwidth used for each network media (step S110).

Then, the packet transfer rule determining module 43 writes the determined transmission ratio in the cache table 22 (step S111) A flow of processing in steps S107, S109, S110 and S111 described above is a case that the bandwidth condition of the application can not be satisfied by one single network media but can be satisfied if using the plurality of network media at the same time.

In this case, the packet transfer rule determining module 43 determines the combination of plural network media that meet the bandwidth condition, and determines the transmission ratio to the respective network media structuring this combination. Then, the packet transfer rule determining module 43 executes the write process in the cache table 22 so that the packets are transferred based on the thus-determined transmission ratio to the output interfaces IF 31 associated respectively with the selected plural network media.

It should be noted that a variety of existing methods can be applied to the transmission ratio determining method. For example, the transmission ratio may be determined so that there remains an unused bandwidth in consideration of the unused bandwidths of the respective network media included in the combination of network media. Alternatively, the transmission ratio may also be determined so that the unused bandwidth of at least one of the network media included in the combination is all used.

For instance, a case to be assumed is that a request bandwidth of the application is on the order of 100 kbps, and this bandwidth condition is met by a combination of two network media. At this time, an unused bandwidth of one network media (referred to as a “media A”) is 70 kbps, an unused bandwidth of the other network media (referred to as a “media B”) is 60 kbps, and the usage bandwidth is determined in the sequence of the media A→the media B.

In this case, the transmission ratio can be determined such as the media A:the media B=7:3 so as to use all the unused bandwidth of the media A. Alternatively, the transmission ratio can be determined such as the media A:the media B=2:3 so as to use all the unused bandwidth of the media B. Still alternatively, the transmission ratio can be also determined such as the media A:the media B=1:1 so that the unused bandwidths are left in the respective media A and B.

Upon finishing the process in step S111, the processing advances to step S113. In step S113, the packet transfer rule determining module 43 calculates the unused bandwidths of one or more network media selected, and updates values of the unused bandwidths in the table 42A.

Next, the packet transfer rule determining module 43 judges whether or not there is the application that does not yet select the network media (step S114). If there is no application that does not select the network media (S114; NO), the processing by the packet transfer rule determining module 43 comes to an end.

By contrast, if there is the application that does not select the network media (S114; YES), the packet transfer rule determining module 43 selects the application showing the next application-to-application priority level, and returns the processing to step S104.

Thus, the packet transfer rule determining module 43 selects one or more network media satisfying the delay condition and the bandwidth condition with respect to each of the remaining applications, determines the transmission ratio to the output interfaces IF 31 associated with one or more network media selected, and writes the thus-determined transmission ratio in the cache table 22.

As discussed above, the packet transfer rule determining module 43 at first selects the network media satisfying the delay condition in the application usage object network media for every application type, and next checks whether the bandwidth condition is met or not.

If there is the single network media that meets the delay condition and the bandwidth condition, the packet transfer rule determining module 43 registers a parameter in the cache table 22 so as to use only this network media. If there are the plurality network media satisfying the delay condition and the bandwidth condition, the packet transfer rule determining module 43 selects, for example, a low-cost network media according to the media usage priority order.

Furthermore, if insufficient of the bandwidth only by the single network media, the packet transfer rule determining module 43 judges whether or not the bandwidth condition is satisfied by combining with other utilizable network media. If the bandwidth condition is satisfied, the packet transfer rule determining module 43 calculates the transmission ratio to each network media in accordance with, e.g., the bandwidth of the network media to be used, and registers a result of the calculation in the cache table 22.

After determining the network media used by one application, when other application is used, the packet transfer rule determining module 43 judges by the same method the network media that should be used for the remaining applications, and registers a result of the judgment in the cache table 22.

As shown above, according to the first embodiment, it is possible to configure the relay device to be used by combining one or more network media on the basis of the request condition of each application.

According to the first embodiment, the process judging unit 40 as the determining section determines, from within the plurality of network media, at least one network media that meets the request condition taking into the consideration the usage mode and the characteristics of the communication application used for the communications. Then, the packet processing module 23 of the packet transfer unit 20 constituting the communication section performs the communications by use of one or more output interfaces 31 associated with at least one determined network media determined.

Thus, the communications can be conducted by selecting at least one network media corresponding to the usage mode and the characteristics of the application. Selected at least one network media satisfying the application characteristics (the delay time and the bandwidth) contained in the request condition. Particularly, if there is not the single network media satisfying the bandwidth condition in the case where there exist the plurality of network media meeting the delay condition with respect to the application, the plurality of network media satisfying the bandwidth condition are selected. The user is thereby able to perform the communications using the applications under a proper environment.

Moreover, the type of the network media that should be used each application is determined in consideration of the application usage mode by the user and other circumstances. Therefore, the user is able to separately use the plurality of applications and the network media under the environment advantageous to the user.

Concretely, according to the communication device in the embodiment, it is possible to solve the problems arising in the following cases.

<Case 1>

In the case of using the electronic mail as the application, the WLAN is not desired to be utilized to prevent the secret (confidential) information contained in the electronic mail from being intercepted.

In this case, the process judging unit 40 determines the network media utilized for using the electronic mail from within the plurality of network media with the WLAN excluded. Accordingly, the WLAN is prevented from being utilized for transmitting the electronic mail, and the secret information is prevented from being intercepted.

<Case 2>

A user X is supplied from a company with a data communication card (a network interface card: corresponding to the output interface 31) for a business use. A type of the application used for the business is predetermined. The user X has a different data communication card for an individual use. Two pieces of data communication cards are attached to a communication device used by the user X in the company. In this case, the user X thinks that the user wants to use only the data communication card supplied from the company for the business.

In this case, a packet transfer rule is determined so that the packet processing module 23 transfers the packet of the application used for the business to only the data communication card (corresponding to the output interface 31) supplied from the company, and content thereof is registered in the cache table 22.

With this scheme, the data communication card (the output interface 31) for the individual use is prevented from being used for transmitting the packet of the application utilized for the business. Accordingly, there is eliminated a necessity of detaching the data communication card for the individual use from the communication device and of changing the setting for the communication device when using the application utilized for the business so that the communication card for the individual use is not used for transmitting the packet of the application utilized for the business. This eliminates a labor for attaching the data communication card for the individual use to the communication device and for changing the setting of the communication device in the case of desiring to use the data communication card for the individual use.

<Case 3>

A charge for using the data communication card obtained by a user Y is imposed on the user on a packet-by-packet basis (by packet-unit). A packet count (the number of packets) is small, and hence it is no problem to use this data communication card on VOIP. If the data communication card is used for downloading the data, however, a charge for use becomes high, and therefore the user Y wants the data communication card not to be used for downloading the data.

In this case, with respect to the applications (e.g., FTP or HTTP) used for downloading the data, the packet transfer rule is determined so that the packet is not transferred to the data communication card (the output interface 31). This scheme can solve the problem.

### Second Embodiment

Next, a second embodiment of the present invention will be discussed. The second embodiment exemplifies an example of applying the communication device in the embodiment to an edge router in an MPLS (Multi Protocol Label Switching) network. Namely, the second embodiment is an embodiment corresponding to a second application pattern shown in FIG. 4. The second embodiment has the common points to the first embodiment and therefore, though omitting the explanations of the common points, focuses on a discussion on different points.

The MPLS network is configured by a plurality of core routers and a plurality of edge routers. Each edge router is disposed (resides) at a boundary between the MPLS network and an external network (such as an access network, etc.) therefrom.

Each edge router retains a path identifier called a label and, when receiving the packet from the external network, attaches a label associated with a destination IP address to the packet, thus sending (forwarding) the packet to the core router. Connections (communication routes) called MPLS label paths (LSPs (Label Switched Paths)) via one or more core routers, are preset between the edge routers. The label is associated with the LSP, and the edge router attaches to the packet a label that designates the LSP associated with the destination IP address of the packet.

Each core router, when receiving the packet, refers to the label attached to the packet and performs forwarding control of the packet so that the packet is forwarded along the LSP associated with the label. Then, the edge router, when receiving the packet attached with the label, detaches the label from the packet and thereafter sends, based on the destination IP address, the packet to the external network outside the MPLS network.

In the second embodiment, the communication device constituting the transmission-sided edge router selects, for every (per) packet, any one of the plurality of LSPs prepared beforehand in accordance with the request condition of each application.

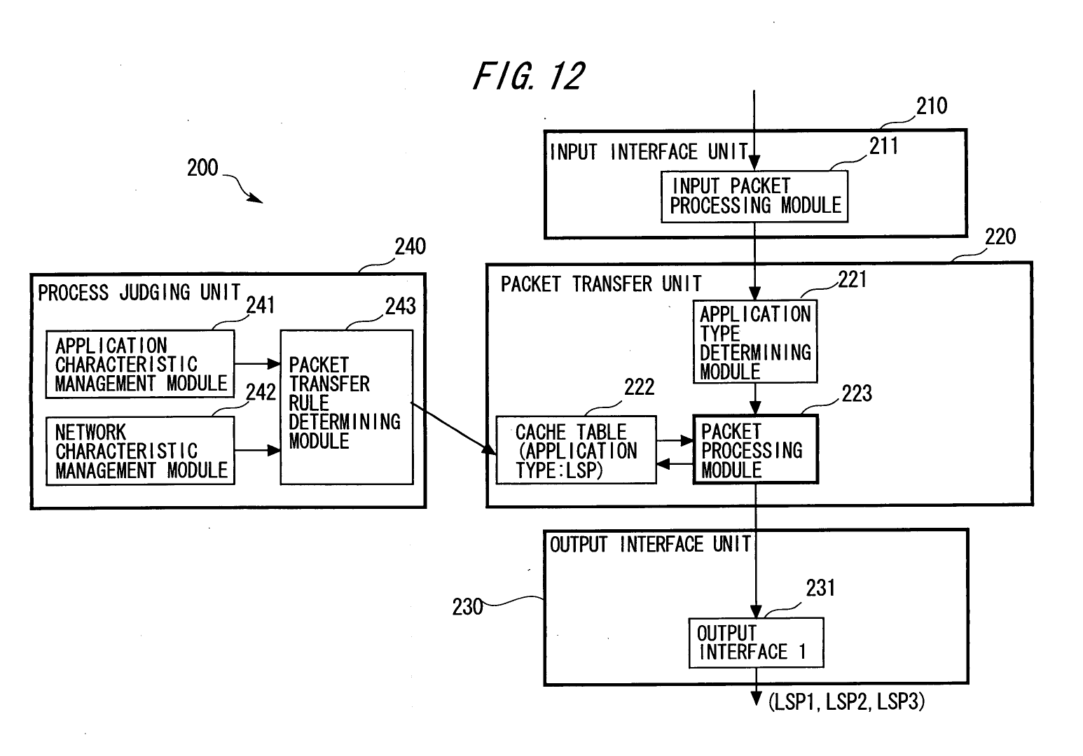

FIG. 12 is a view showing an example of a configuration of a communication device 200 applied to the second embodiment. The communication device 200 includes an input interface unit 210, a packet transfer unit 220, an output interface unit 230 and a process judging unit 240.

The input interface unit 210 has an input packet processing module 211. The packet transfer unit 220 has an application type determining module 221, a cache table 222 and a packet processing module 223. The output interface unit 230 has an output interface 231. The process judging unit 240 has an application characteristic management module 241, a network characteristic management module 242 and a packet transfer rule determining module 243.

Thus, the configuration of the communication device 200 is substantially the same as the communication device 1 has. An object of the selection made by the packet processing module 223 is not the network media (the output IF) but the LSP. Therefore, the second embodiment differs from the first embodiment as below.

In FIG. 12, the cache table 222 is registered, according to every application type, with the LSP used for a next packet arriving at the input interface unit 210. A plurality of LSPs, i.e., three LSPs (LSP1, LSP2 and LSP3) is prepared in this example.

The packet processing module 223 obtains from the cache table 222 an LSP number associated with a result of determination (e.g., a port number) of the application type of the packet that is acquired by the application type determining module 221. Then, the packet processing module 223, as packet processing, if in the case of, e.g., Ethernet (registered trademark, attaches the packet with a label associated with the LSP number read from the cache table 222, and outputs the labeled packet to the output interface unit 230.

The output interface unit 230 has only one output interface 231 and sends each packet attached with the label associated with the LSP to the MPLS network. Note that the output interface unit 230 may have a plurality of output interfaces 231.

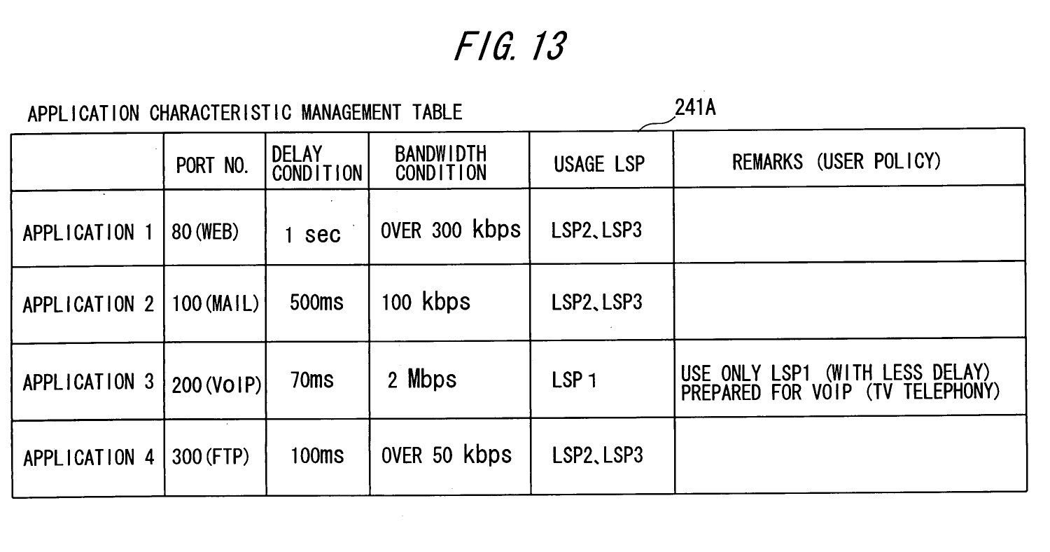

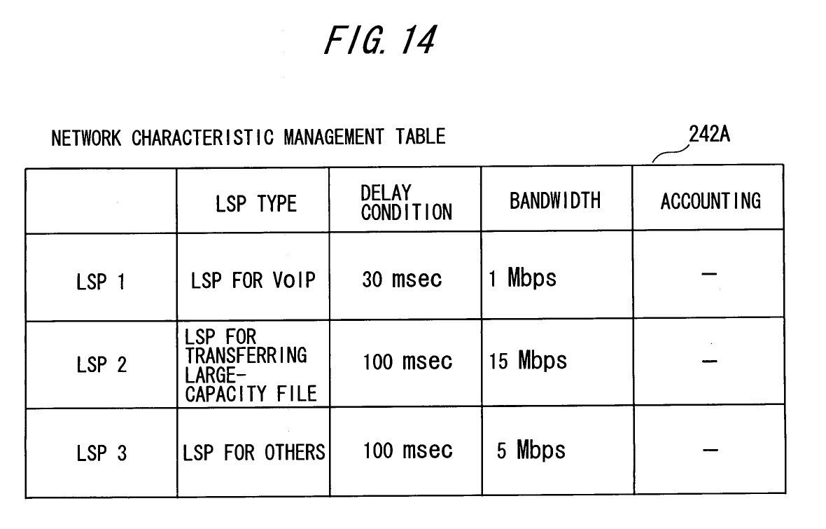

FIG. 13 is a diagram showing an example of an application characteristic management table 241A retained by the application characteristic management module 241. FIG. 14 is a diagram showing an example of a network characteristic management table 242A retained by the network characteristic management module 242.

As shown in FIG. 13, the application characteristic management table 241A is stored, for every application type, with a port number, characteristic information of a delay condition, characteristic information of a bandwidth condition, a should-be-used LSP number, and a user policy for selecting the LSP. Further, as shown in FIG. 14, the network characteristic management table 242A is stored, for every LSP, with an LSP type, a delay condition (transfer delay time), a bandwidth (unused bandwidth) and accounting information.

In the examples shown in FIGS. 13 and 14, the LSP1 is specially prepared as a less-delay path for VoIP. Accordingly, only the LSP1 is used for the application type “VoIP (port number “200”). Then, the setting is such that the LSP2 and the LSP3 are used for the respective applications excluding VoIP.

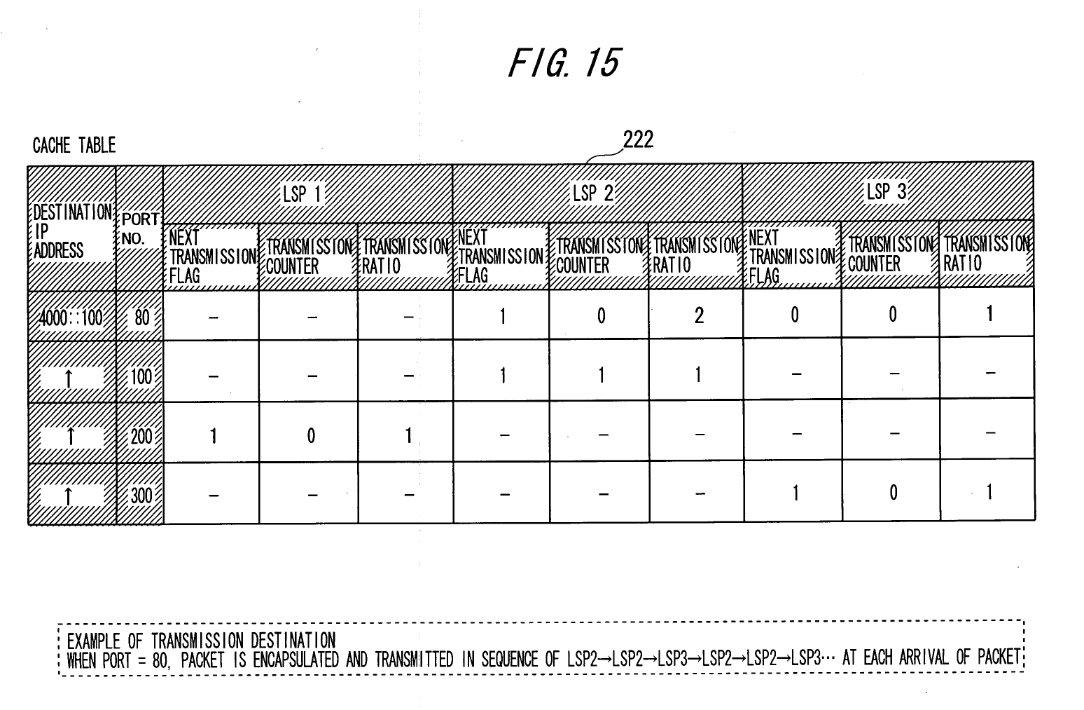

FIG. 15 is a diagram showing a structure of the cache table 222 in the second embodiment. A result of packet transfer rule determination made by the packet transfer rule determining module 243, is written in this cache table 222.

In the cache table 222, a next transmission flag, a transmission counter and a transmission ratio are prepared for every LSP, which replace the output IFs. Except this point, the structure of the cache table 222 is the same as that of the cache table 22 explained in the first embodiment.

For instance, in the example shown in FIG. 15, the setting for the application 1 having a port number “80” is that the LSP2 and the LSP3 are selected, and the packet is transmitted in the sequence (the transmission ratio=LSP2:LSP3=2:1) such as LSP2→LSP2→LSP3→LSP2→LSP2→LSP3 . . . .

Shown further is an example, wherein the cache table 222 illustrated in FIG. 15 has such setting (the transmission ratio=LSP1:LSP2:LSP3=1:0:1) that only the LSP1 is used for VoIP (a port number “200”).

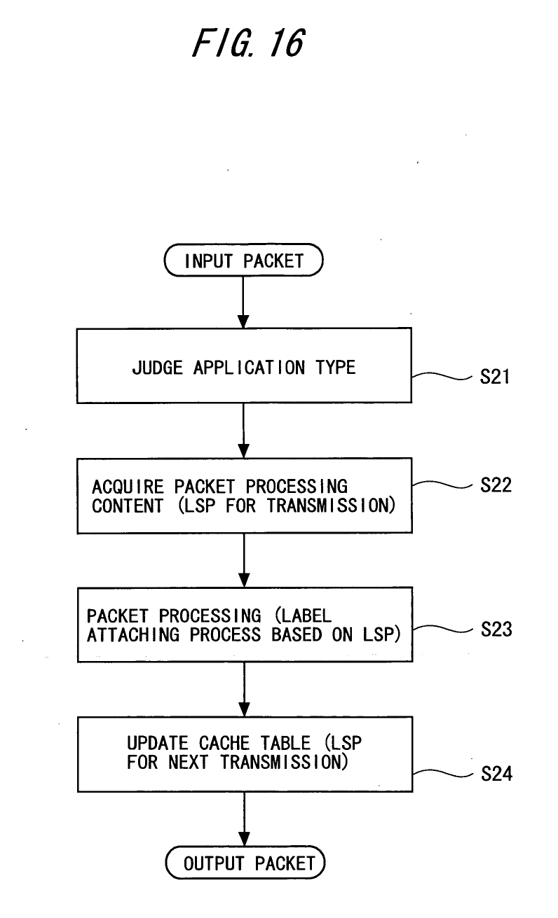

FIG. 16 is a flowchart showing an operation sequence of the communication device 200 (the packet transfer unit 220) when the packet arrives. The processes in S21 through S24 shown in FIG. 16 are the same as those in the first embodiment except that in step S22, the packet processing module 223 obtains an LSP number associated with a transfer destination by searching through the cache table 222 in a way that uses the port number (associated with the application type) gained (extracted) from the packet as a key (step S22), and, as the packet processing, the packet is attached with a label associated with the LSP so as to be forwarded along the LSP having the obtained LSP number (step S23) and is thus transferred to the output interface unit 230.

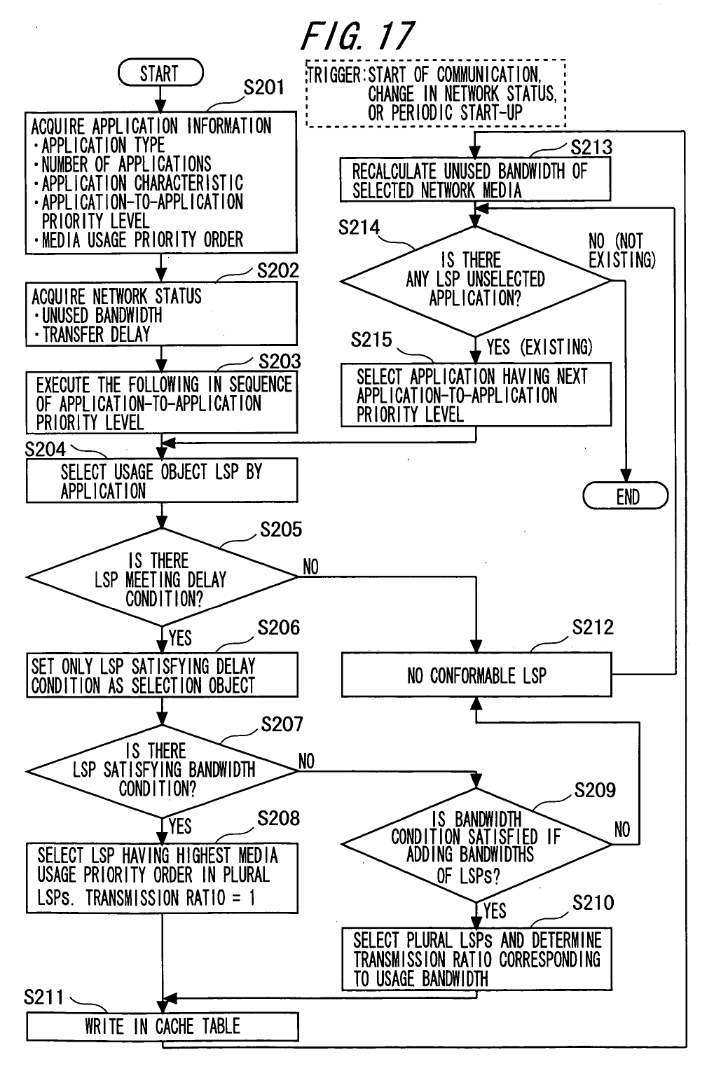

FIG. 17 is a flowchart showing a packet transfer rule determining sequence by the packet transfer rule determining module 243. The basic operation of the packet transfer rule determining module 243 is the same as that in the first embodiment, and it is judged which LSP is selected for every application type. To be specific, the respective processes in steps S201 through S215 shown in FIG. 17 are processes, wherein the selection object “the network media (the output IF (network interface))” in the processes in steps S101 through S115 shown in FIG. 11 is replaced with the “LSP.” Hence, the detailed explanation thereof is omitted.

According to the second embodiment, at least one LSP satisfying the request condition of each application is selected, and the packet processing is executed upon each packet so that the packet is forwarded along the selected LSP. The packet can be thereby transferred under the condition optimal to the application and to the user.

### Third Embodiment

Next, a third embodiment of the present invention will be explained. The third embodiment exemplifies an example of applying the communication device explained in the outline of the embodiment to a home agent based on the mobile IP. Namely, the third embodiment is an embodiment corresponding to the third application pattern shown in FIG. 5. The third embodiment has the common points to the first embodiment and therefore, though omitting the explanations of the common points, focuses on a discussion on different points.

In the mobile IP network, a mobile node (Mobile Node: MN) defined as a receiving terminal uses two types of addresses. One address is a Home Address (HoA) and is managed on a router called a Home Agent for managing the mobile node. Another address is a Care-of-Address (CoA) acquired by the mobile node in an area (a foreign network) to which the mobile node moves (visits).

The mobile node, upon acquiring the CoA, sends a position registration message (termed Binding Update) containing the CoA to the Home Agent. The Home Agent, when receiving the position registration message, registers the CoA contained in this message and HoA in a storage area called a binding cache (Binding Cache) in a way that associates the CoA and the HoA with each other. The terminal for transmitting the packet to the mobile node transmits the packet by designating the HoA of the mobile node as a destination address. The packet is invariably received by the Home Agent. The Home Agent, upon a receipt of the packet, obtains the CoA associated with the HoA by referring to the Binding Cache. Then, the Home Agent encapsulates the packet with the CoA and transmits the encapsulated packet to the mobile node. Thus, a scheme is that the packet is to reach the mobile node irrespective of whatever position the mobile mode exists in.

The mobile node is capable of using simultaneously a plurality of CoAs. Namely, the mobile node can register the plurality of CoAs in association with the HoA. The third embodiment will give a discussion on the Home Agent that forwards the packet to this type of mobile node (the receiving terminal). In the third embodiment, the communication device constituting the Home Agent selects, for every packet, anyone of the plurality of CoAs registered by a certain mobile node (a receiving terminal) on the basis of the request condition of each application.

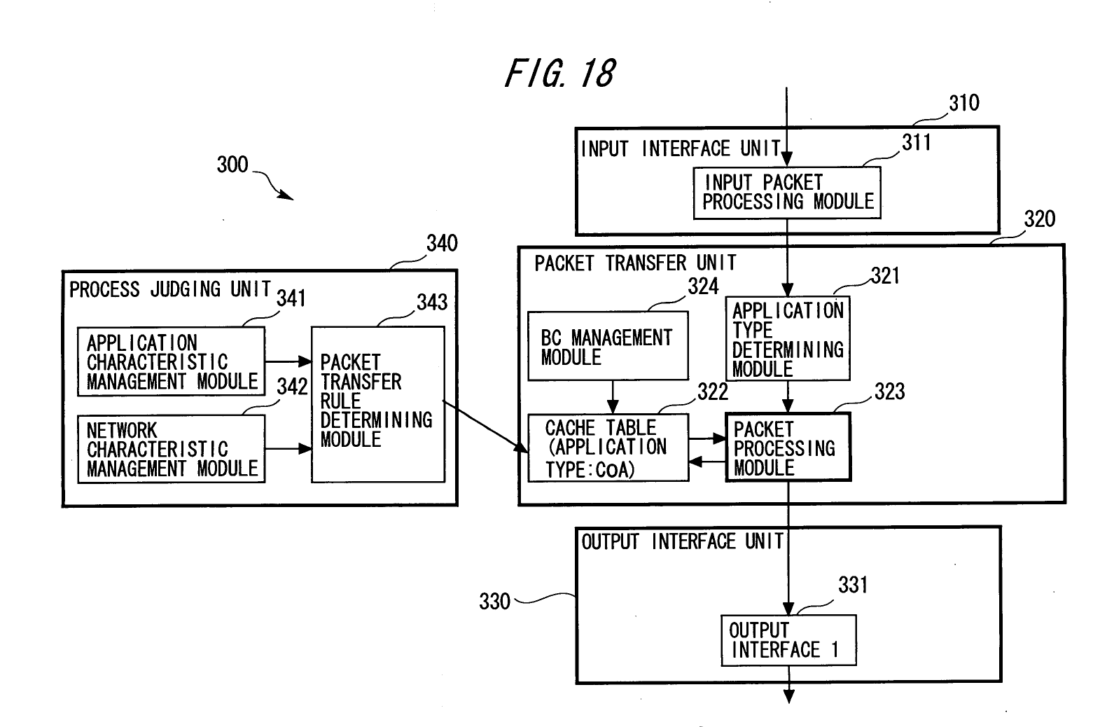

FIG. 18 is a view showing an example of a configuration of a communication device 300 applied to the third embodiment. The communication device 300 has, as in the first embodiment and the second embodiment, an input interface unit 310, a packet transfer unit 320, an output interface 330 and a process judging unit 340.

The input interface unit 310 includes an input packet processing module 311. The packet transfer unit 320 includes an application type determining module 321, a cache table 322, a packet processing module 323 and a binding cache (BC) management module 324. The output interface unit 330 includes an output interface 331. The process judging unit 340 includes an application characteristic management module 341, a network characteristic management 342 and a packet transfer rule determining module 343.

Thus, the configuration of the communication device 300 serving as the Home Agent can be actualized by substantially the same functional configuration as the communication device 1 shown in FIG. 2 has. The example in FIG. 18, however, shows a case that the output interface unit 330 has only one output interface. The output interface unit 330 may be provided with a plurality of output interfaces 331.

Further, the communication device 300 receives, as described above, the position registration message from the mobile node, and registers the CoA contained in this message in the Binding Cache.

Herein, the communication device 300 can simultaneously utilize the plurality of network media as in the first embodiment. In this case, it is considered that the mobile node registers the CoAs different for every network media type in the Binding Cache, and separately uses the CoAs corresponding to the network media. On the other hand, the communication device 300, as in the first embodiment, selects one or more network media that meet the request condition for every application type.

Accordingly, the communication device 300 determines, based on the request condition of each application, which CoA is selected for encapsulating and thus transmitting the packet. Therefore, the packet transfer rule determining module 343 of the process judging unit 340 stores the cache table 322 with the CoAs used in association with the application types, and the packet processing module 323 selects, according to the content stored in the cache table 322, the CoA as the destination address used when encapsulating the packet.

The same tables as the respective tables 41A and 42A shown in FIGS. 7 and 8 in the first embodiment can be applied as an application characteristic management table retained by the application characteristic management module 341 and a network characteristic management table retained by the network characteristic management module 342 in the third embodiment.

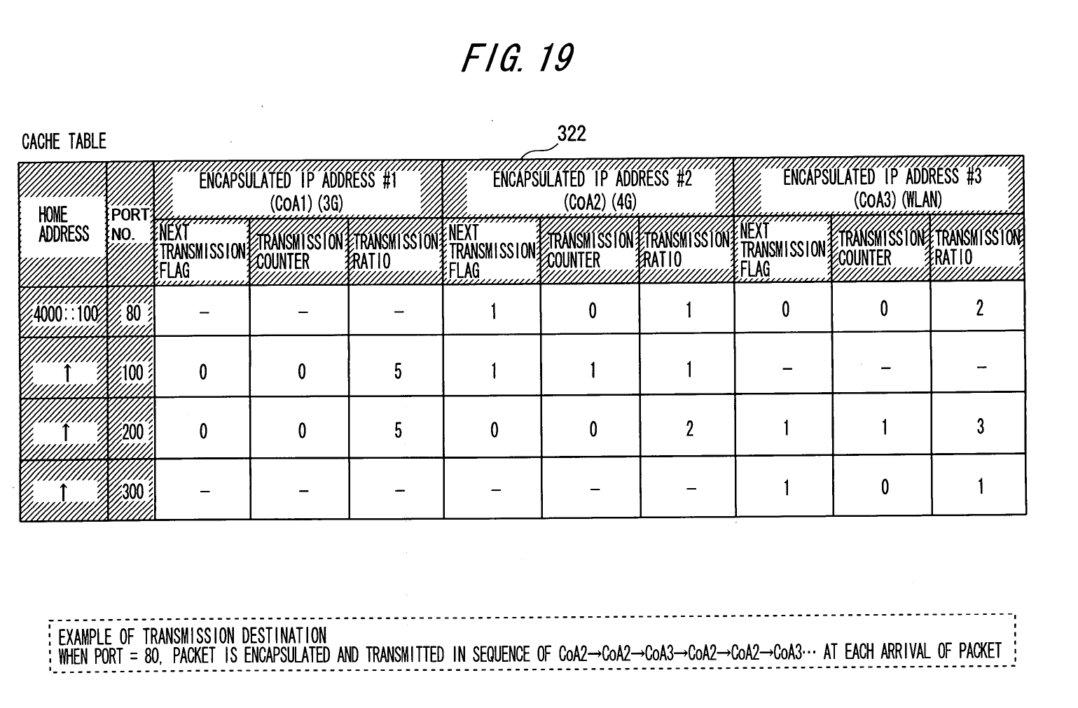

FIG. 19 is a diagram showing an example of a structure of the cache table 322 in the third embodiment. The cache table 322 is structured serving as the Binding Cache (BC) and is created (organized) on a home-address-by-home-address basis (home address unit).

For example, the cache table 322 in an initial status is created when registering the HoA. The cache table 322 in this initial status is created by, e.g., the BC management module 324 shown in FIG. 18. The BC management module 324 is built up to receive the position registration message (Binding Update) from the mobile node, which is received by the input interface unit 310. This position registration message contains the CoA associated with the HoA and the network media type information associated with the CoA.

The BC management module 324, when receiving the position registration message, extracts the CoA and the network media type from this message, and creates fields in which to write a next transmission flag, a transmission counter and a transmission ratio for every application type (the port number) with respect to the CoA and the network media type in the cache table 322 assuming the initial status. Further, the BC management module 324, in the case of receiving the position registration message related to updating of the CoA, writes the CoA related to the updating in the cache table 322 and updates the CoA.

Note that when Mobile IPv6 (IP version 6) is applied, a scheme can be taken, wherein part (prefix) of the CoA is used as an identifier of the network media type, and the BC management module 324 deduces an associated network media type from the CoA. In this case, it is not required that the network media type be contained in the position registration message. Further, there may also be taken such a scheme that the processing by the BC management module 324 is executed in the packet processing module 323, whereby the BC management module 324 can be omitted.

FIG. 19 shows an example in which CoA1 for 3G, CoA2 for 4G and CoA3 for WLAN are registered with respect to a certain HoA in the cache table 322. As in the first embodiment, the packet transfer rule determining module 343 executes writing the transmission ratio and default setting in the next transmission flag in the cache table 322. Then, the packet processing module 322 performs the control of the transmission counter and the next transmission flag when the packet arrives.

The example shown in FIG. 19 represents a status in such a case that the packet transfer rule determining module 343, with respect to the application having, e.g., a port number “80”, selects CoA2 (4G) and CoA3 (WLAN), determines a transmission ratio thereof to be 1:2, and effects the setting so that CoA2 is used in preference to CoA3 (the default setting in the next transmission flag for CoA2).

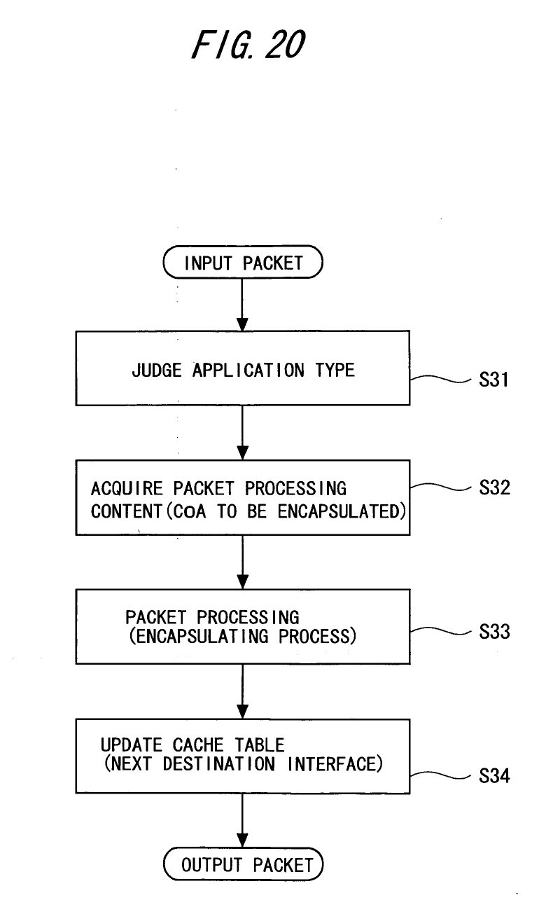

FIG. 20 is a flowchart showing an operation sequence at a packet arrival time in the communication device (the home agent) in the third embodiment. FIG. 20 shows processes particularly by the application type determining module 321 and the packet processing module 323 of the packet transfer unit 320.

The processes in steps S31 through S34 in FIG. 20 are substantially the same as the processes in steps S01 through S04 shown in FIG. 10. In step S32, however, the packet processing module 323 specifies the cache table 322 that should be referred to, from the HoA set as the destination address of the packet, and searches the thus-specified cache table 322 for the CoA in a way that uses the application type (the port number) as a key, thereby acquiring the CoA to be used when encapsulating the packet.

Moreover, in step S33, the packet processing module 323 encapsulates the packet by using the acquired CoA. Then, the encapsulated packet is forwarded to the output interface unit 330 and is then sent from the output interface 331.

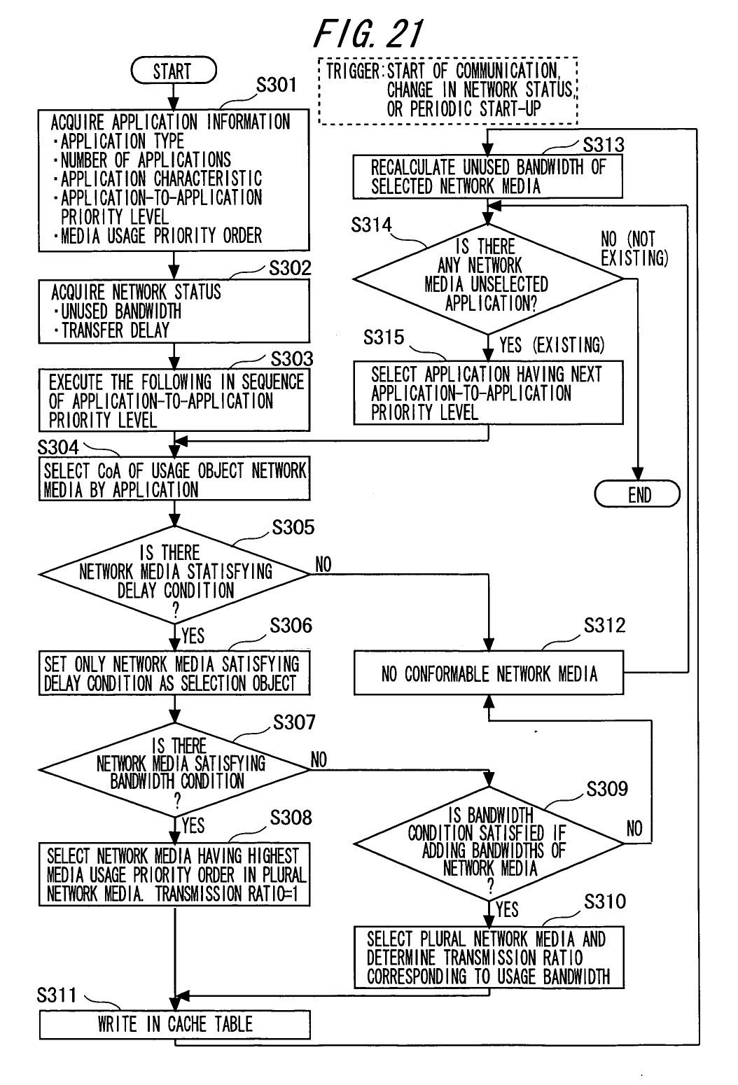

FIG. 21 is a flowchart showing a packet transfer rule determining sequence in the communication device (the home agent) in the third embodiment. This sequence is carried out by the packet transfer rule determining module 343.

The packet transfer rule determining module 343 selects, from within the usage object network media, the network media satisfying the request condition of the application by taking into consideration conditions (such as the bandwidth, the delay, etc.) between the CoA of the mobile node and the Home Agent.

The processes in steps S301 through S315 shown in FIG. 15 are substantially the same as the processes in steps S101 through S115 shown in FIG. 11. In step S304, however, a different point from the first embodiment is that simultaneously when selecting the network media, the CoA associated with this network media is selected.

As a substitute for this scheme, however, in steps S304 through S310, one or more network media satisfying the delay condition and the bandwidth condition of the application are selected, the transmission ratio of each network media is determined, and this transmission ratio may be written in a field of the CoA associated with the selected network media in step S311. In this case, the processing itself of the packet transfer rule determining module 343 becomes the same as that in the first embodiment.

As shown above, according to the third embodiment, it is possible to configure the mobile IP Home Agent using the network media in a way that combines one or more network media in accordance with the request condition of the application. The packet can be thereby forwarded to the receiving terminal by using one or more network media optimal to the application.

### Fourth Embodiment

Next, a fourth embodiment of the present invention will be discussed. The fourth embodiment exemplifies an example of applying the communication device explained in the outline of the embodiment to a mobile node (MN) based on the mobile IP. Namely, the fourth embodiment is an embodiment corresponding to the fourth application pattern shown in FIG. 6. The fourth embodiment has the common points to the first embodiment and therefore, though omitting the explanations of the common points, focuses on a discussion on different points.

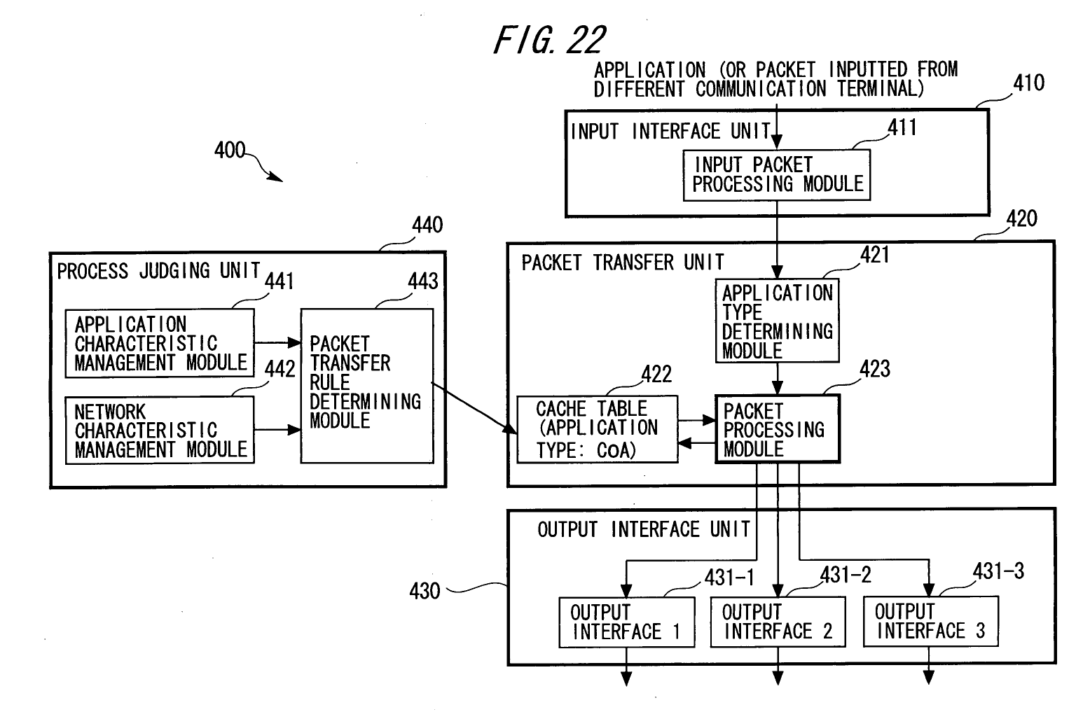

FIG. 22 is a functional block diagram showing an example of a configuration of a communication device 400 applied to the fourth embodiment. Illustrated is the configuration of the communication device 400 as a transmission-sided mobile node. The communication device 400 has, as in the first embodiment, an input interface unit 410, a packet transfer unit 420, an output interface unit 430 and a process judging unit 440.

The input interface unit 410 includes an input packet processing module 411. The packet transfer unit 420 includes an application type determining module 421, a cache table 422 and a packet processing module 423. The output interface unit 430 includes a plurality of output interfaces 431 (431-1,431-2,431-3). The process judging unit 440 includes an application characteristic management module 441, a network characteristic management module 442 and a packet transfer rule determining module 443.

Thus, the configuration of the communication device 400 serving as the mobile node can be actualized by substantially the same functional configuration as the communication device 1 shown in FIG. 2 has. To be specific, the communication device 400, when receiving the packet transmitted by the application of the mobile node or by an application of other terminal, selects any one of the output interfaces 431 usable by the communication device 400, and transmits the packet by use of this interface 431.

The following point is, however, different from the communication device 1. The Mobile IP based mobile node, in the case of transmitting the packet addressed to other terminal, transmits the packet through a reverse tunnel between the MN and the Home Agent in order for the packet to appear as if being transmitted from a home network via the Home Agent. Namely, the mobile node generates (assembles) the packet by encapsulation in a way that sets the CoA of the self-device as an origination address (source address) and sets the address of the Home Agent as a destination address (in an inner packet, the source address is the HoA, the destination address is the address of the communication partner terminal. In an outer packet, the source address is the CoA, and the destination address is the address of the Home Agent).

Herein, the communication device 400 registers the plurality of CoAs prepared for every network media in the home agent. In this example, the communication device 400 registers the first CoA (CoA1) associated with the 3G network, the second CoA (CoA2) associated with the 4G network and the third CoA (CoA3) associated with the WLAN respectively in the home agent.

The process judging unit 440 determines the packet transfer rule so that the CoA associated with at least one network media satisfying the request condition of each application usable by the communication device 400 is set as a source address in the outer packet, and writes a result of this rule determination in the cache table 422.

The cache table 422 is structured so that when the packet processing module 423 executes searching by using the packet application type as a key, the CoA associated therewith is to be read. The packet processing module 423 creates (assembles) an inner IP packet in a way that sets, as a content of the packet processing, the HoA as a source address and the (home) address of the receiving terminal as a destination address, and thus executes the encapsulation process. The origination (source) address of the outer packet when encapsulated is set to the CoA read from the cache table 422, and the Home Agent address is set to the destination address of the outer packet. Then, the thus assembled packet is transferred to the output interface 431 associated with the CoA (the network media).

In the plurality of output interfaces 431, at least one output interface 431 is prepared for the network media. In this example, the output interface 431-1 is connected to the 3G network, and the CoA1 is assigned thereto. Further, the output interface 431-2 is connected to the 4G network, and the CoA2 is assigned thereto. Then, the output interface 431-3 is connected to the WLAN, and the CoA3 is assigned thereto.

The same tables as the respective tables 41A and 42A shown in FIGS. 7 and 8 can be applied as an application characteristic management table retained by the application characteristic management module 441 and a network characteristic management table retained by the network characteristic management module 442.

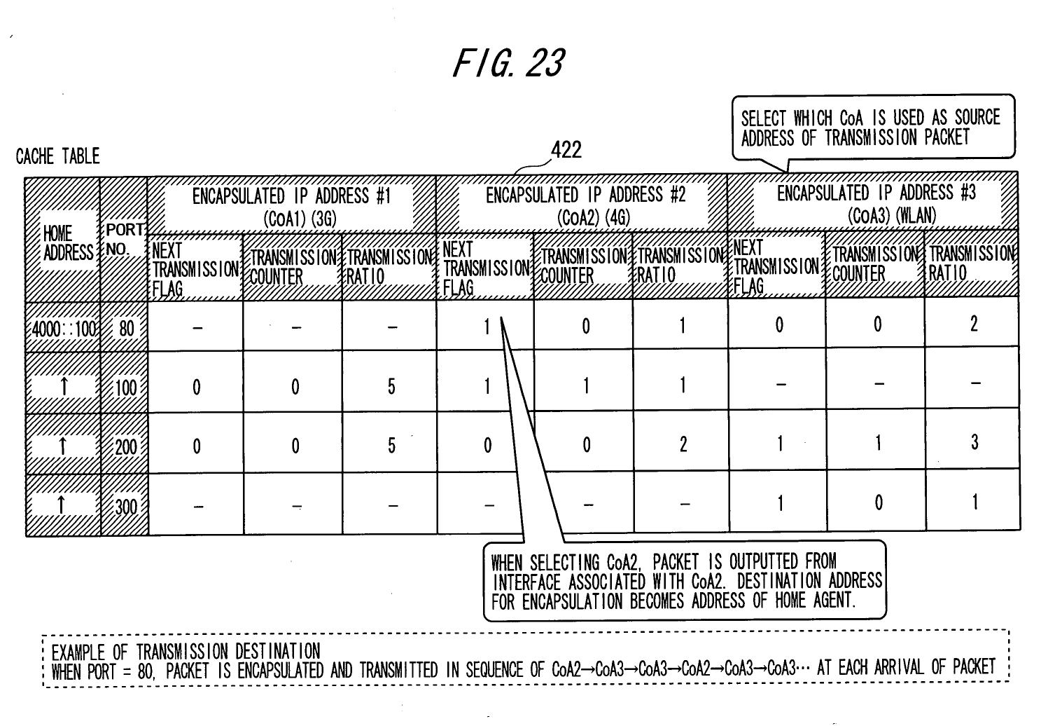

FIG. 23 is a diagram showing an example of a structure of the cache table 422 in the fourth embodiment. The cache table 422 is structured so that a next transmission flag, a transmission counter and a transmission ratio are registered for every CoA according to every port number (the application type).

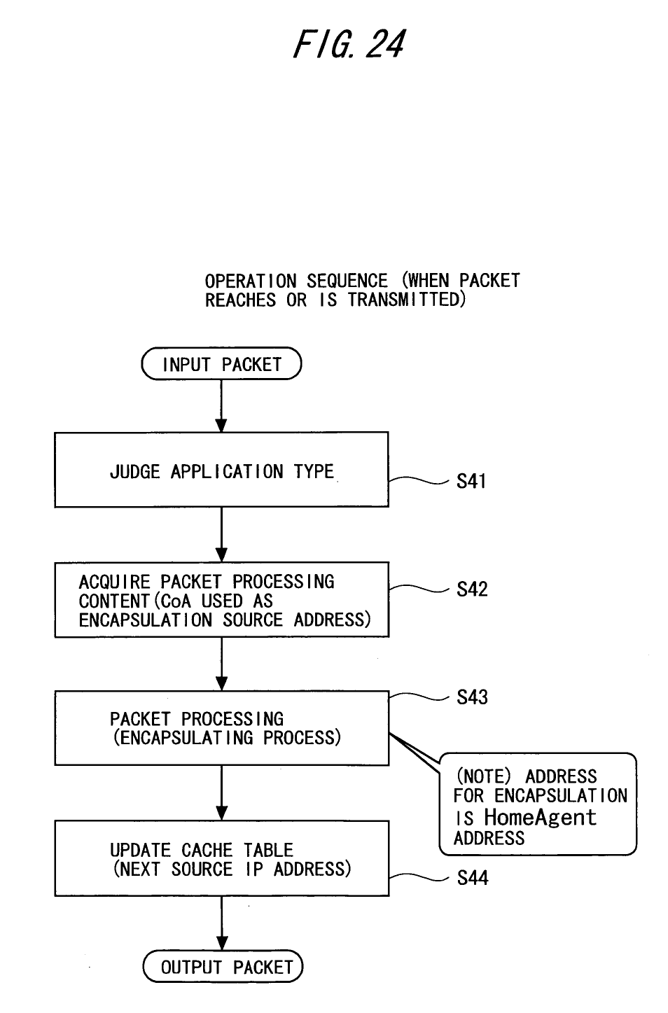

FIG. 24 is a flowchart showing an operation sequence when transmitting the packet in the communication device 400 (the mobile node) in the fourth embodiment. FIG. 24 shows processes especially by the application type determining module 421 and the packet processing module 423 of the packet processing unit 420.

The processes in steps S41 through S44 in FIG. 24 are substantially the same as the processes in steps S01 through S04 shown in FIG. 10. In step S42, however, the packet processing module 423 acquires the CoA associated with the application type of the inputted packet from the cache table 422.

Further, the packet processing module 423, in step S43, encapsulates the inputted packet with a packet in which the acquired CoA is set to the source address and the Home Agent address is set to the destination address. Then, the packet processing module 423 forwards the encapsulated packet to the output interface unit 431 associated with the CoA.

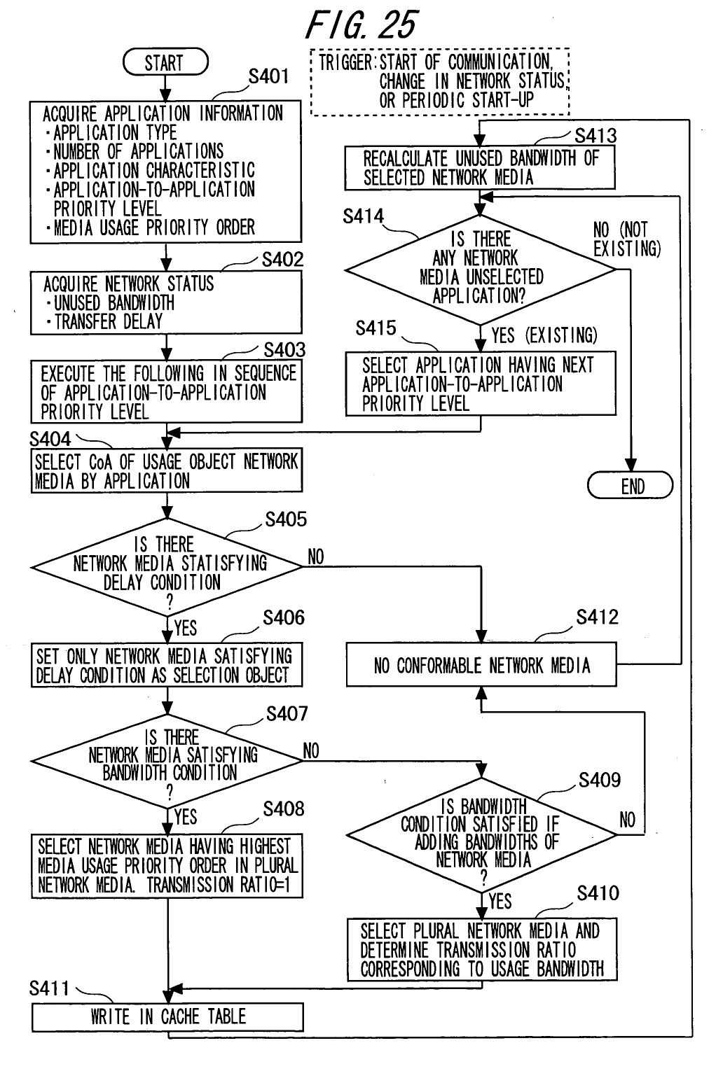

FIG. 25 is a flowchart showing a packet transfer rule determining sequence in the communication device 400 (the mobile node) in the fourth embodiment. This sequence is executed by the packet transfer rule determining module 443.

The packet transfer rule determining module 443 selects, from within the application usage object network media, at least one network media satisfying the conditions in consideration of the delay condition and the bandwidth condition requested by the application.

Processes in steps S401 through S415 shown in FIG. 25 are substantially the same as the processes in steps S101 through S115 shown in FIG. 11. A different point from the first embodiment is, however, such that in step S404, the CoA associated with the network media is selected simultaneously with the selection of the network media.

According to the fourth embodiment, the communication (the packet transmission) can be performed by selecting one or more CoAs satisfying the request condition of the application.

[Operational Effects of Embodiments]

According to the embodiments of the present invention discussed above, only one or more network media that meet the application request are selected corresponding to the characteristics of the plurality of network media and are simultaneously utilized, thereby enabling the application request to be met while supplementing a lack of the bandwidth. In particular, the network media utilized for every application can be selected, and the optimum communications with no stress can be performed in a way that automatically reflects an intention of the end user.

The configurations explained in the embodiments discussed above can be properly combined within the scope that does not deviate from the object of the present invention.

[Others]

The embodiments of the present invention described above disclose the following claimed inventions. The components of the following inventions can be properly combined according to the necessity. Moreover, inventions of a method, a program and a program storage medium each having the same features as those of the present invention of the communication device that follows, are established as the present inventions.

What is claimed is:

1. A communication device capable of communicating with a receiving device by simultaneously using a plurality of network media existing between the receiving device and the communication device, comprising:
a determining section determining, from within the plurality of network media, at least one network media satisfying a request condition of a communication application used for the communication; and
a communication section performing the communication with the receiving device by use of at least one network media.

2. A communication device capable of communicating with a receiving device by simultaneously using a plurality of network media existing between the receiving device and the communication device, comprising:
a plurality of network interfaces of which at least one network interface is prepared for each network media;
a determining section determining, from within the plurality of network media, at least one network media satisfying,a request condition of a communication application used for the communication; and
a communication section performing the communication with the receiving device by use of at least one network interface associated with at least one network media.

3. A communication device according to claim 2, wherein the request condition contains a delay time condition and a bandwidth condition, and
the determining section extracts one or more network media satisfying the delay time condition from within the plurality of network media that should be used for the communication application, and if a single network media out of the extracted network media can satisfy the bandwidth condition, this single network media is determined as at least one of the network media satisfying the request condition of the communication application, but if no such network media exists and if a combination of two or more network medias out of the extracted network media can satisfy the bandwidth condition, this combination of two or more network medias bundled as one is determined as at least one of the network media satisfying the request condition of the communication application.

4. A communication device according to claim 2, wherein the communication section includes:
an application type determining section judging a communication application type of a packet that should be transmitted to the receiving device for every packet; and
a packet processing section selecting, for every packet, one of the one or more network interfaces associated with at least one network media satisfying a communication quality condition requested by the judged communication application type, and transferring the packet to the selected network interface so that the packet is sent from the selected network interface.

5. A communication device according to claim 4, wherein the determining section determines the ratio of the packets sent to each network media when a combination of two or more network media bundled as one has been determined as at least one of the network media satisfying the request condition of the communication application, and
the packet processing section executes a process of transferring the packets to the selected network interfaces according to the determined ratio.

6. A communication device according to claim 3, wherein the plurality of network media that should be used for the communication application are extracted from within the plurality of network media existing between the receiving device and the communication device in consideration of a usage mode and/or a characteristic of the communication application.

7. A communication device capable of communicating with a receiver device by simultaneously using a plurality of routes set between the receiving device and the communication device, comprising:
a determining section determining, from within the plurality of routes, at least one route satisfying a request condition of a communication application used for the communication; and
a communication section performing the communication with the receiving device by use of at least one route.

8. A communication device according to claim 7, wherein the request condition contains a delay time condition and a bandwidth condition, and
the determining section extracts one or more routes satisfying the delay time condition from within the plurality of routes that should be used for the communication application, and if a single route out of the extracted routes can satisfy the bandwidth condition, this single route is determined as at least one of the routes satisfying the request condition of the communication application, but if no such route exists and if a combination of two or more routes out of the extracted routes can satisfy the bandwidth condition, this combination of two or more routes bundled as one is determined as at least one of the routes satisfying the request condition of the communication application.

9. A communication device according to claim 7, wherein the communication section includes:
an application type determining section judging a communication application type of a packet that should be transmitted to the receiving device for every packet; and
a packet processing section selecting, for every packet, one of at least one route satisfying a communication quality condition requested by the judged communication application type, and executing a process, upon the packet, for transferring the packet along on the selected route.

10. A communication device according to claim 9, wherein each of the routes is a label path set based on MPLS (Multi Protocol Label Switching), and
the process for transferring the packet along on the selected route includes a process of attaching to the packet a label associated with the label path as the selected route.

11. A communication device according to claim 8, wherein the plurality of routes that should be used for the communication application are extracted from within the plurality of routes set between the receiving device and the communication device in consideration of a usage mode and/or a characteristic of the communication application.

12. A communication device capable of communicating with a receiving device by simultaneously using a plurality of addresses retained by the receiving device, comprising:
a determining section determining, from within the plurality of addresses, at least one address satisfying a request condition of a communication application used for the communication; and
a communication section performing the communication with the receiving device by use of at least one address.

13. A communication device according to claim 12, wherein the request condition contains a delay time condition and a bandwidth condition, and
the determining section extracts one or more network media satisfying the delay time condition from within the plurality of network media that should be used for the communication application and that is associated with any one of the plurality of addresses, and if a single network media out of the extracted network media can satisfy the bandwidth condition, the address associated with this single network media is determined as at least one of the addresses satisfying the request condition of the communication application, but if no such network exists and if a combination of two or more network media out of the extracted network media can satisfy the bandwidth condition, two or more addresses corresponding to this combination of two or more network are determined as at least one address group satisfying the request condition of the communication application.

14. A communication device according to claim 12, wherein each of the addresses is assigned to any one the plurality of network media usable by the communication device for the communication.

15. A communication device according to claim 12, wherein the communication section includes:
an application type determining section judging a communication application type of a packet that should be transmitted to the receiving device for every packet; and
a packet processing section selecting, for every packet, one of at least one address satisfying a communication quality condition requested by the judged communication application type, and executing a process, upon the packet, for transmitting the packet addressed to the selected address.

16. A communication device according to claim 15, wherein each of the plurality of addresses is a care-of-address associated with a home address of the receiving device, and
the process for transmitting the packet addressed to the selected address includes a process of encapsulating the packet with a packet of which a destination address is the care-of-address serving as the selected address.

17. A communication device according to claim 13, wherein the plurality of network media that should be used for the communication application are extracted from within the plurality of network media existing between the receiving device and the communication device in consideration of a usage mode and/or a characteristic of the communication application.

18. A communication device having a plurality of addresses and capable of communicating with a receiving device by simultaneously using two ore more addresses among these plural addresses, comprising:
a determining section determining , from within the plurality of addresses, at least one address satisfying a request condition of a communication application used for the communication; and
a communication section performing the communication with the receiving device by use of at least one address.

19. A communication device according to claim 18, wherein the request condition contains a delay time condition and a bandwidth condition, and
the determining section extracts one or more network media satisfying the delay time condition from within the plurality of network media that should be used for the communication application and that is associated with any one of the plurality of addresses, and if a single network media out of the extracted network media can satisfy the bandwidth condition, the address associated with this single network media is determined as at least one of the addresses satisfying the request condition of the communication application, but if no such network media exists and if a combination of two or more network media out of the extracted network media can satisfy the bandwidth condition, the two or more addresses corresponding to this combination of two or more network addresses is determined as at least one of the address groups satisfying the request condition of the communication application.

20. A communication device according to claim 18, wherein each of the addresses is assigned to any one the plurality of network media usable by the communication device for the communication.

21. A communication device according to claim 18, wherein the communication section includes:
an application type determining section judging a communication application type of a packet that should be transmitted to the receiving device for every packet; and
packet processing section selecting, for every packet, one of at least one address satisfying a communication quality condition requested by the judged communication application type, and executing a process, upon the packet, for transmitting to the receiving device the packet in which the source address is the selected address.

22. A communication device according to claim 21, wherein at least one address is a care-of-address possessed by the communication device serving as a mobile node, and
the process for transmitting to the receiving device the packet in which the source address is the selected address, includes a process of transmitting to the receiving device serving as a home agent in a way that encapsulates a packet in which the destination address is the home address of the mobile node corresponding to a destination node of the packet, with a packet in which the source address is a care-of-address corresponding to the selected address.

23. A communication device according to claim 19, wherein the plurality of network media that should be used for the communication application are extracted from within the plurality of network media existing between the receiving device and the communication device in consideration of a usage mode and/or a characteristic of the communication application.

24. A communication system having a plurality of routes to a desired destination, selecting only the one or more routes satisfying a request condition of an application from within the plurality of routes in accordance with the request condition of the application, and transmitting data by use of the selected one or more routes.
